(19) United States
(12) Patent Application Publication
(10) Pub. No.: US 2024/0393893 A1
(43) Pub. Date: Nov. 28, 2024

(54) Posture-Adaptive Ferromagnetic Mousepad Magnetized Mouse System

(71) Applicant: Keahi Chun, Honolulu, HI (US)

(72) Inventor: Keahi Chun, Honolulu, HI (US)

(73) Assignee: LabeL Free LLC, Honolulu, HI (US)

(21) Appl. No.: 18/670,717

(22) Filed: May 21, 2024

Related U.S. Application Data
(60) Provisional application No. 63/468,490, filed on May 23, 2023.

(51) Int. Cl. G06F 3/039; G06F 3/0354

(52) U.S. Cl. CPC G06F 3/0395; G06F 3/03543

(57) ABSTRACT

The present disclosure pertains to an innovative ergonomic system comprising a posture-adaptive ferromagnetic mousepad and a magnetized mouse, both designed to significantly enhance user comfort and efficiency during extended computer use. The mousepad, constructed from ferromagnetic material, supports seamless interaction with the magnetized mouse, ensuring continuous adherence and precise pointer tracking. A distinctive feature is the mousepad's ability to be positioned in three dimensions (x, y, and z axes), facilitated by an integrated mounting mechanism adaptable to various support structures such as articulated arms, clamps, or stands. The mousepad's adjustability allows for a neutral wrist posture, reducing repetitive stress injuries, and can even accommodate a fully inverted position, offering unparalleled ergonomic flexibility. The magnetized mouse, optimized to weigh 70 grams or less, is specifically designed to interact seamlessly with the mousepad, promoting optimal wrist and arm positioning. This system integrates smoothly with existing setups, enhancing interaction precision and maintaining healthy postures, catering to a diverse user base with customizable ergonomic preferences.

### FIELD OF THE INVENTION

This invention pertains to the technical field of ergonomic computer peripherals, specifically introducing innovative designs for a posture-adaptive ferromagnetic mousepad and a magnetized mouse. The mousepad can be ergonomically positioned in three dimensions (x, y, and z axes) for optimal user comfort, facilitated by an articulating assembly or other suitable support structures, allowing mounting to various surfaces and adjustable to the user's preferred posture. A key feature of the mousepad is its ability to support a fully inverted position, providing exceptional ergonomic flexibility. Additionally, the invention encompasses a magnetized mouse designed to interact seamlessly with the ferromagnetic mousepad, enhancing the overall ergonomic and functional experience. Together, these components form a comprehensive system that allows users to maintain neutral wrist postures, reduce repetitive stress injuries, and customize their ergonomic setup for optimal comfort and productivity.

### BACKGROUND OF THE INVENTION

The evolution of computer peripherals has significantly focused on enhancing user interface efficiency while often overlooking ergonomic considerations. Traditional mousepads, typically featuring a planar surface designed to optimize mouse tracking, fail to address the ergonomic needs of users, leading to discomfort and potential repetitive stress injuries. Despite aesthetic variations in size, color, and design, these mousepads remain restricted to a flat orientation, paralleling the desk surface. This design necessitates wrist pronation—a position linked to the development of musculoskeletal issues over prolonged computing sessions.

Recent advancements have introduced ergonomic solutions like vertical mice attempting to mitigate wrist strain by altering grip posture. However, these adaptations do not fully address the limitations of mousepad positioning nor the varied ergonomic needs of individuals. Moreover, the fixed, level positioning of traditional mousepads does not accommodate posture variety or the dynamic movements encouraged by modern ergonomic research to prevent repetitive stress injuries. Studies published by the Ergonomics Health Association have highlighted the need for peripherals that adapt more comprehensively to the user's natural movements to mitigate the risk of long-term injuries.

The advent of the internet and the resultant increase in computer usage time have further highlighted the inadequacies of current mousepad designs in supporting healthy, comfortable computer interaction. The need for a mousepad that offers adjustable positioning in three dimensions—thereby accommodating a neutral wrist posture and promoting varied user postures—has become evident. Such innovation would not only enhance ergonomic posture but also integrate seamlessly with existing computing environments and equipment.

### SUMMARY OF THE INVENTION

The present invention introduces a novel system comprising a posture-adaptive ferromagnetic mousepad and a magnetized mouse, both designed to significantly enhance the ergonomics of computer mouse tracking use. The mousepad features a planar body made of ferromagnetic material, enabling secure attachment and precise positioning of the magnetized mouse. This base is complemented by a surface finish optimized for accurate mouse tracking.

In this invention, the posture-adaptive ferromagnetic mousepad, coupled with the magnetized mouse, offers unprecedented ergonomic customization by enabling a full range of positional adjustments, including complete inversion for operating the mousepad upside-down. This versatile system features an articulating assembly, such as a variable friction articulated arm with multiple articulating joints, that allows for precise, user-defined positioning across the x, y, and z axes. Such adjustability not only promotes a neutral wrist posture to reduce the risk of repetitive stress injuries but also accommodates fully supinated wrist positions, transcending conventional ergonomic limits. Moreover, the seamless integration with various mounting options—including clamps, stands, fixture-tracks, magnets, suction devices, or other securing mechanisms—ensures versatile and stable engagement with different surfaces. This flexibility supports highly customized ergonomic setups, catering to a diverse user base with unique needs, and underscores the novel and non-obvious advantages of the system.

The magnetized mouse, an integral part of this system, is specifically designed to work in tandem with the ferromagnetic surface of the mousepad, ensuring that it maintains adherence without excessive friction, facilitating smooth and precise pointer movements.

Through innovative design and functional integration of the mousepad and magnetized mouse, this invention aims to offer unprecedented ergonomic customization, improving comfort, productivity, and health outcomes for individuals engaged in prolonged computer use.

### BRIEF DESCRIPTION OF DRAWINGS

The drawings included in this patent application illustrate various embodiments of the Posture-Adaptive Ferromagnetic Mousepad, the Magnetized Mouse, and their components, designed to enhance ergonomic flexibility and user comfort. In these drawings:

FIG. 1-FIG. 5: These figures provide various perspectives of the Posture-Adaptive Ferromagnetic Mousepad which may be attached to a variety of support structures via its mounting mechanism for enhanced positional adjustability.

FIG. 6-FIG. 13: These figures provide various perspectives of a second embodiment of the Posture-Adaptive Ferromagnetic Mousepad, each illustrating the integration with a variable friction articulated arm for enhanced positional adjustability.

FIG. 14: An exploded view detailing the detachable connection between the Posture-Adaptive Ferromagnetic Mousepad and the articulated arm, showcasing the ease of assembly and adjustment.

FIG. 15-FIG. 22: These figures exhibit additional embodiments showing the Posture-Adaptive Ferromagnetic Mousepad attached to different support structures like clamps, stands, and extendable stands, illustrating the versatility in positioning the mousepad for optimal ergonomic alignment.

FIG. 23-FIG. 26: Focus on embodiments where the mousepad is attached to furniture-specific fixture-tracks, such as those found on chairs and desks, highlighting the adaptability of the mousepad to various user environments.

FIG. 27-FIG. 36: Provide detailed views of the fixture-track, an attachment mechanism compatible with an articulated arm for furniture surface integration.

FIG. 37: An exploded close-up view illustrating the precise assembly of the mousepad's articulated arm to a fixture-track, showcasing the detailed components and their functionality.

FIG. 38-FIG. 39: These figures depict the Posture-Adaptive Ferromagnetic Mousepad in a typical usage environment, showcasing how a hand operates a typical or magnetized mouse in an ergonomic setup.

FIG. 40-FIG. 42: These figures display different views of a magnetized mouse specifically designed for use with the Posture-Adaptive Ferromagnetic Mousepad.

FIG. 43: This figure illustrates a magnetized mouse clinging to the Posture-Adaptive Ferromagnetic Mousepad, tilted at a 90-degree angle. The image demonstrates the mouse's stability and the effective magnetic interaction with the mousepad's surface, even when positioned vertically, it clings to the surface without support from the user's hand.

FIG. 44 depicts a dual-image view of a rubber trim for wrapping the edge of the mousepad's planar body, enhancing aesthetics, providing safety from sharp edges, and serving as a tactile boundary for the magnetized mouse.

Other objects, features, and advantages of the present invention will be explained in the following detailed description of preferred embodiments with reference to the appended drawings.

### DETAILED DESCRIPTION OF PREFERRED EMBODIMENTS

In the following detailed description of the subject matter hereof, one or more preferred embodiments are illustrated with certain specific details of implementation. However, it will be recognized by one skilled in the art that many other variations and modifications may be made and/or practiced in analogous applications or environments. It should be noted that methods, procedures, components, or functions that are commonly known to persons of ordinary skill in the field of the invention are not described in detail herein so as to avoid unnecessarily obscuring a concise description of the preferred embodiment.

The Posture-Adaptive Ferromagnetic Mousepad is meticulously engineered for seamless interaction with a magnetized mouse, enabling adjustable three-dimensional positioning to significantly enhance ergonomic usage. The mousepad's ferromagnetic surface is designed to ensure that the magnetized mouse maintains just enough adherence to facilitate smooth and precise pointer tracking, without creating excessive friction. This careful balance of magnetic attraction helps keep the mouse securely in place, even when it's not being moved. Such a design not only prioritizes user comfort and efficiency but also meets diverse ergonomic needs and accommodates various working styles, making it an essential tool for anyone seeking to maintain healthy wrist and forearm positions during extended computer use.

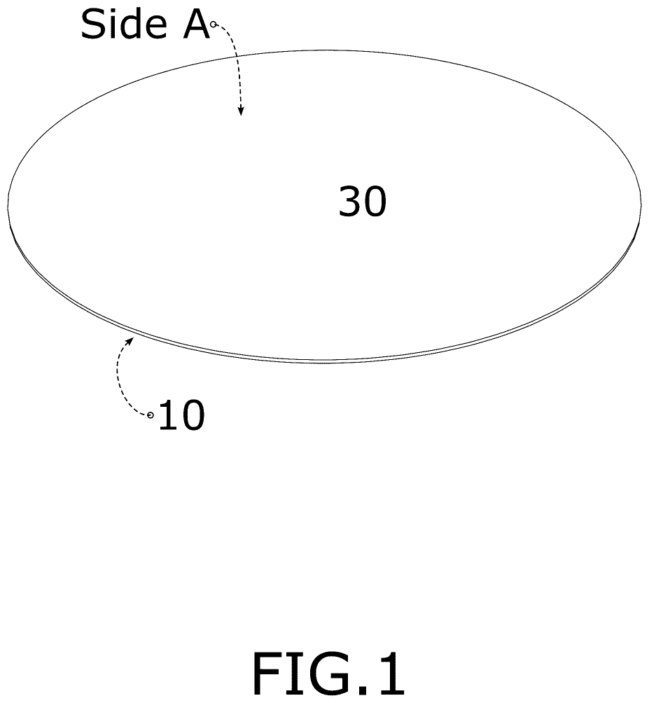

Referring to FIG. 1, the Posture-Adaptive Ferromagnetic Mousepad is depicted with a planar body 10, shown in a preferred circular-cylindrical configuration, adaptable also to semi-circle, oval, cuboid, or polygonal shapes to meet diverse user preferences and workspace requirements. The planar body of this embodiment has a thickness of 1.2 mm and is constructed from ferromagnetic metal. The planar body securely anchors a magnetized mouse, maintaining attachment through a range of operational orientations—from slight tilts to fully inverted positions. The top surface finish 30, typically a premium-grade fabric, is fine-tuned for optimal mouse pointer tracking. This surface is engineered to achieve an ideal balance between friction and magnetic force, ensuring smooth mouse movement and dependable tracking. These design features effectively prevent excessive mouse slipping and accidental detachment, supporting consistent contact with the mousepad under various angular positions. This functionality is pivotal in providing an ergonomic setup that substantially reduces wrist strain and enhances comfort across diverse user-adjustable computing postures.

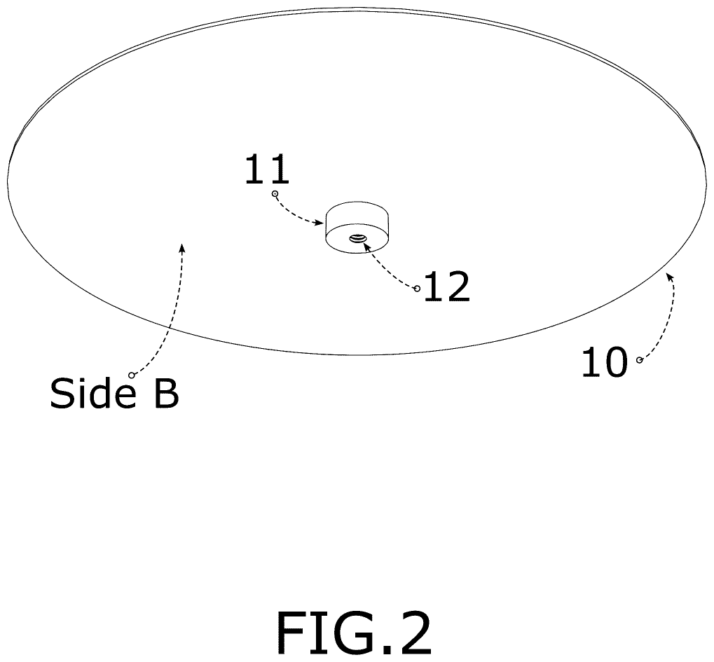

Referring to FIG. 2, the back-bottom-right perspective view showcases a preferred embodiment of the Posture-Adaptive Ferromagnetic Mousepad, emphasizing the mounting mechanism which includes both the mounting structure 11 and its mounting hole 12 in this embodiment of the mounting mechanism. This embodiment features a mounting hole 12, specifically designed as a threaded hole of size ¼ inch diameter by 20 threads per inch (¼″-20 UNC), tailored to accommodate a compatible bolt for secure and versatile mounting to various support structures. This standardized threaded hole specification allows for effective adaptation to diverse workstation configurations. An essential discovery in this design is the method of attaching the mounting structure 11 to the planar body. Considering the 1.2 mm thickness of the metal forming the planar body, traditional methods such as welding or using screws are unsuitable, as they would significantly distort the plane's flatness, crucial for optimal mouse tracking. Welding would introduce warping due to high heat, while screws could deform the surface. Hence, the mounting structure 11 is adhered using a specialized adhesive, which provides a strong, reliable bond without compromising the integrity of the flat surface. This method of attaching the mounting structure 11 with a specialized adhesive required experimentation, and was not immediately obvious to the research and development team, which highlights one of the non-obvious aspects of the mousepad while ensuring the durability and functionality necessary for precision tracking. The bottom surface Side B, shown here, is exposed sheet metal in this embodiment, underscoring the sleek and efficient engineering of the assembly.

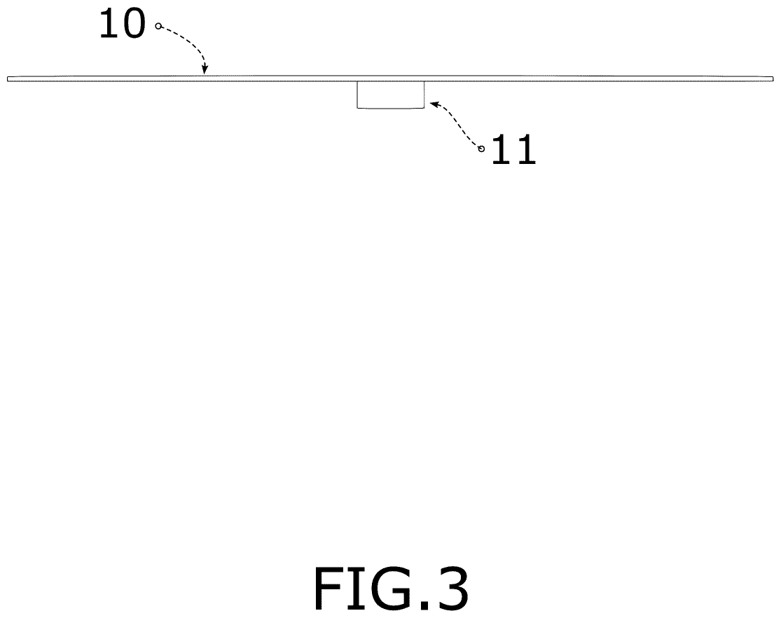

FIG. 3 presents a comprehensive perspective view of the Posture-Adaptive Ferromagnetic Mousepad from the left, right, front, and back, illustrating a preferred embodiment where all views are identical, showcasing the mousepad's symmetrical design in this embodiment. The figure displays the planar body 10 and the mounting structure 11, highlighting the seamless integration of these components.

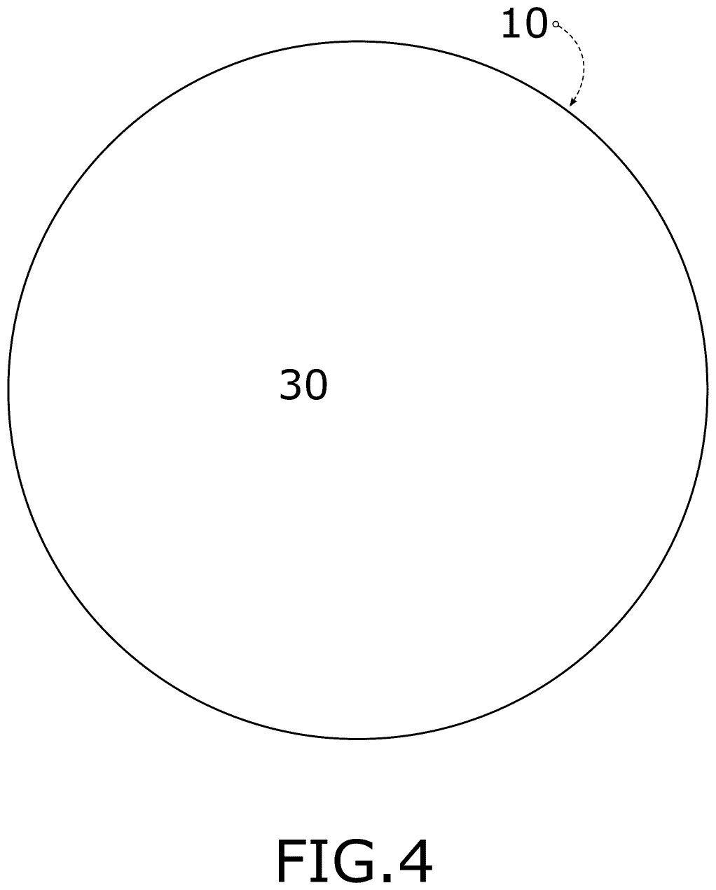

FIG. 4 presents a top perspective view of the Posture-Adaptive Ferromagnetic Mousepad, specifically highlighting the circular top surface finish 30 of this embodiment. The design of this surface is optimized for enhanced mouse tracking accuracy. The specific materials and the microscopic texture of the surface finish 30, although its details are not visible, are chosen to optimize pointer tracking and tactile response while ensuring durability and consistent performance. A typical example of such a surface finish 30 is a thin fabric with an adhesive backing, adhered to the planar body 10. This type of tracking surface finish is crucial for high-precision applications such as graphic design and detailed data manipulation, where smooth and accurate pointer movement is paramount.

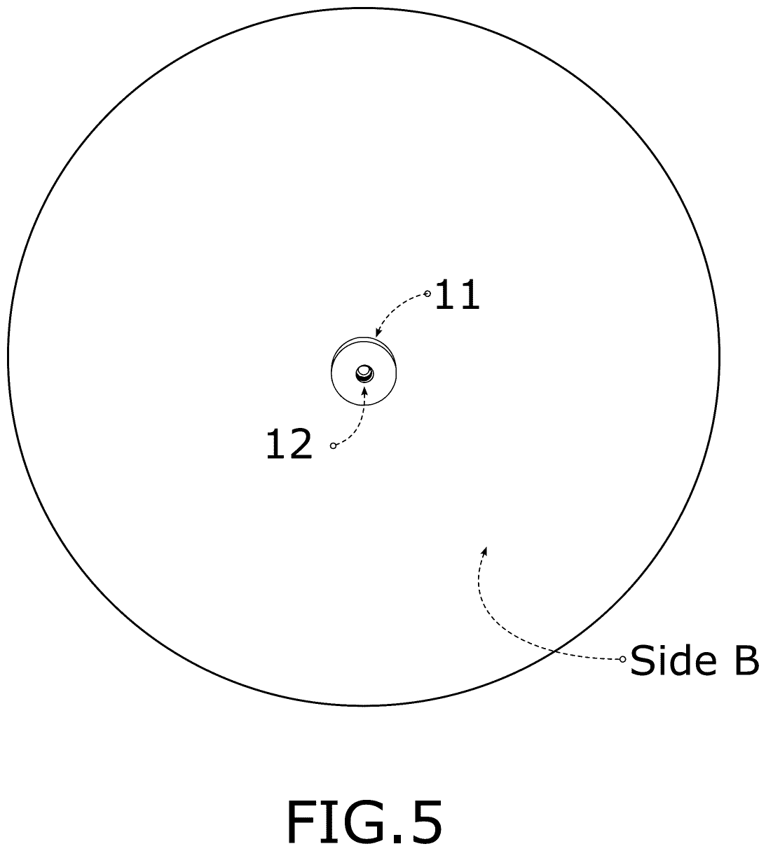

FIG. 5 offers a bottom perspective view of the Posture-Adaptive Ferromagnetic Mousepad, specifically focusing on the bottom Side B where the mounting mechanism is featured. This view highlights the mounting hole 12 and mounting structure 11 of this embodiment, which is designed to accept threaded bolts for secure attachment to various support structures, facilitating easy integration into diverse ergonomic setups. The design and placement of the mounting structure 11 is centered in this embodiment, but may be integrated in other locations on the bottom Side B. This mounting mechanism exemplifies the mousepad's adaptability, allowing it to be securely fixed in a range of computing environments.

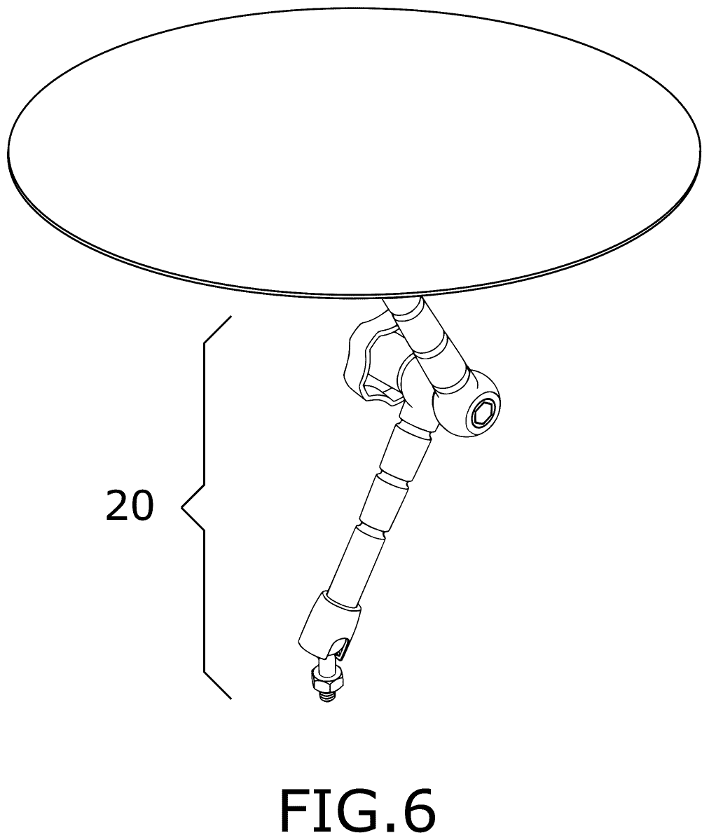

FIG. 6 presents a front-top-left perspective view of the Posture-Adaptive Ferromagnetic Mousepad, showcasing a second embodiment equipped with a variable friction articulated arm (Magic Arm) 20. This arm is designed to attach securely to the mounting hole, enhancing the mousepad's flexibility in positioning. The articulated arm 20 allows for user-defined adjustments in height and angle, ensuring optimal ergonomic alignment for various computing tasks. This feature is particularly beneficial in environments requiring frequent adjustments to the user's posture or workspace configuration, such as in multi-user setups or adjustable desk environments.

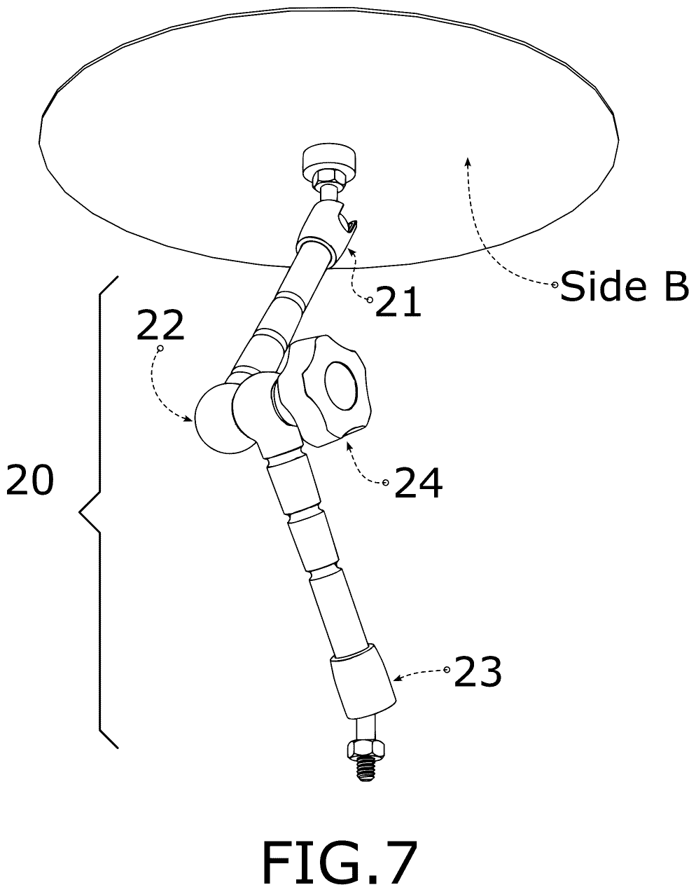

FIG. 7 offers a back-bottom-right perspective view of the second embodiment of the Posture-Adaptive Ferromagnetic Mousepad, displaying the bottom-surface Side B and key components of the variable friction articulated arm 20, commonly referred to as a ‘Magic Arm’ 20. This view highlights the arm's crucial joints and adjustment mechanisms: the wrist 21, elbow 22, friction control knob 24, and shoulder 23. Each component is utilized for precise control over the positioning of the mousepad, enabling users to tailor the setup to their ergonomic needs. The friction control knob 24 allows for fine-tuning the resistance of the joints, ensuring stability and ease of movement. This configuration is particularly effective in dynamic work environments where frequent repositioning is necessary to maintain comfort and enhance productivity.

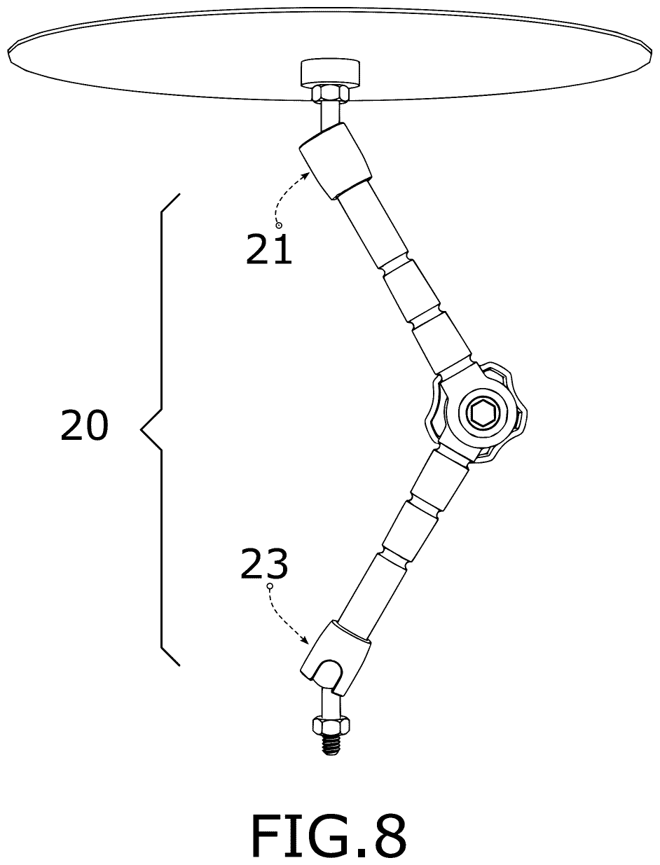

FIG. 8 presents a left perspective view of the second embodiment of the Posture-Adaptive Ferromagnetic Mousepad, featuring the variable friction articulated arm 20, commonly referred to as a ‘Magic Arm’ 20. In this view, the Magic Arm 20 is connected to the mousepad through a mounting hole, which is obscured because it is engaged with one end of the arm. This illustration highlights two critical joints of the Magic Arm 20: the wrist 21 and the shoulder 23. These components are essential for allowing detailed and user-defined adjustments to the mousepad's position, supporting precise angling modifications for ergonomic customization.

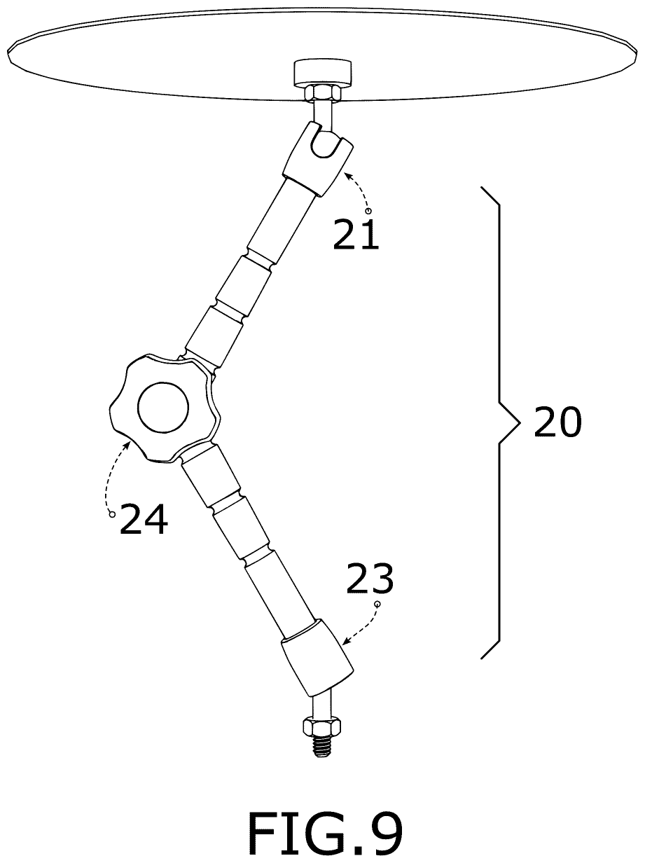

FIG. 9 displays a right perspective view of the second embodiment of the Posture-Adaptive Ferromagnetic Mousepad, featuring the variable friction articulated arm 20, commonly referred to as a ‘Magic Arm’ 20. This arm 20 is connected to the mousepad through its mounting hole, which remains obscured in this view due to its engagement with one end of the arm. Prominently visible in this perspective are critical adjustable components of the Magic Arm 20: the wrist 21, the friction control knob 24, and the shoulder 23. These elements are pivotal in enabling precise and user-specific adjustments, allowing for detailed control over the mousepad's orientation and height. The friction control knob 24 plays a key role in modulating the resistance at various joints, enhancing the adaptability and stability of the setup, crucial for maintaining ergonomic integrity during use.

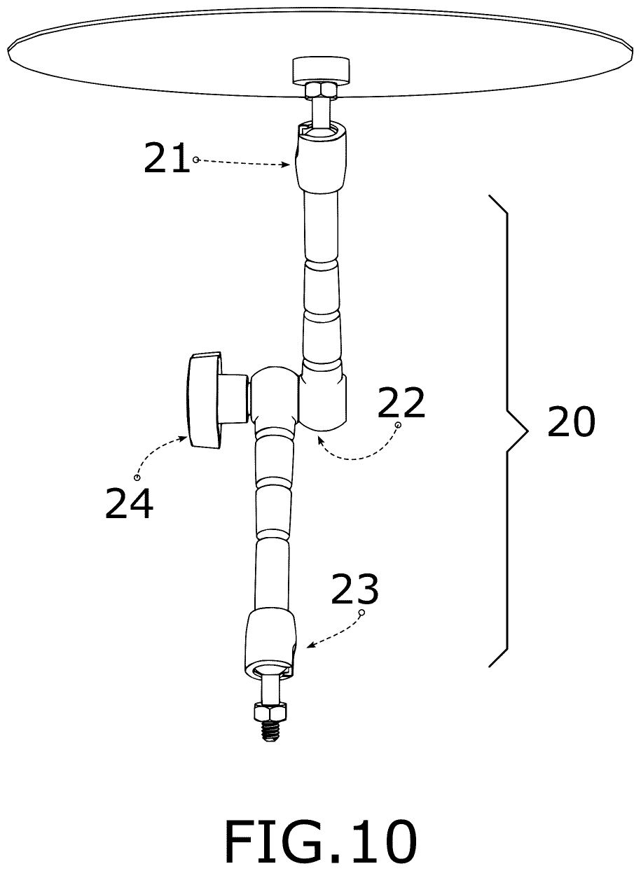

FIG. 10 offers a front perspective view of the second embodiment of the Posture-Adaptive Ferromagnetic Mousepad, featuring the variable friction articulated arm 20. This arm 20 is connected to the mousepad via a mounting hole, which is not visible from this perspective due to the insertion of one end of the arm. This view exposes key components of the Magic Arm 20 that enable comprehensive ergonomic adjustments: the wrist 21, elbow 22, friction control knob 24, and shoulder 23. These elements facilitate precise control over the positioning of the mousepad, allowing users to adjust the height, angle, and orientation to suit individual ergonomic needs. The friction control knob 24 is particularly significant, as it allows for fine-tuning the resistance of the arm's joints.

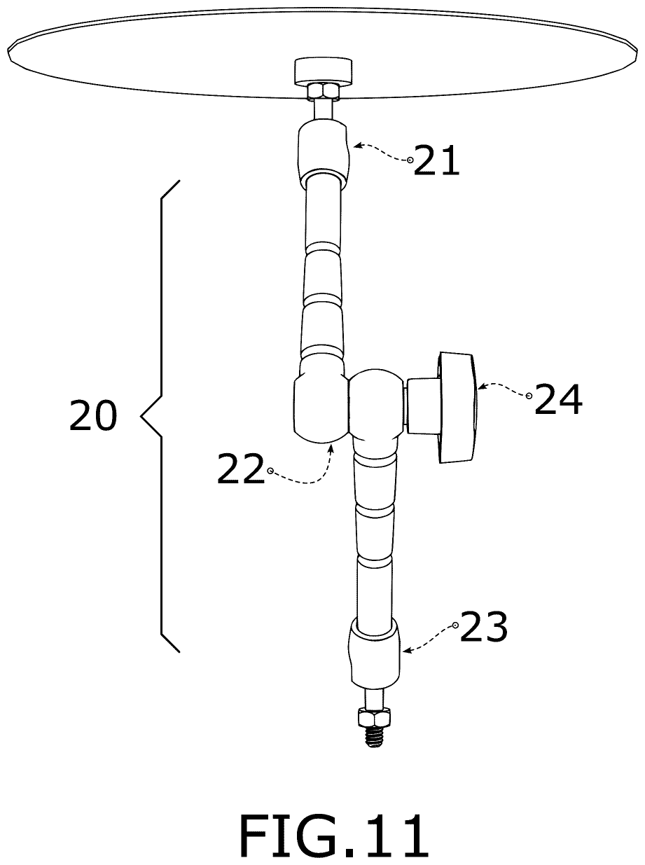

FIG. 11 provides a back perspective view of the second embodiment of the Posture-Adaptive Ferromagnetic Mousepad, featuring the variable friction articulated arm 20, known as a ‘Magic Arm’ 20. In this perspective, the Magic Arm 20 is engaged with a mounting hole, which is not visible due to its connection point being obscured by the arm's insertion. This view highlights the critical components of the Magic Arm 20: the shoulder 21, elbow 22, wrist 23, and the friction control knob 24. Each of these parts plays a vital role in facilitating adjustable ergonomic positioning of the mousepad, allowing users to tailor its angle, height, and orientation to their specific needs. The visibility of these components in this view underscores their importance in achieving precise control and customization of the mouspad's height and angle.

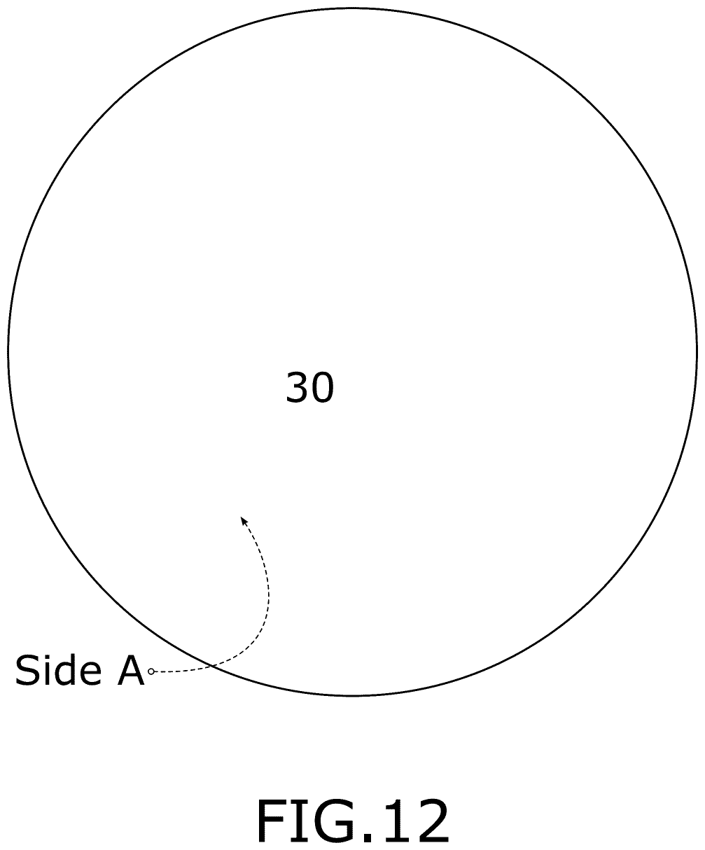

FIG. 12 presents a top perspective view of the second embodiment of the Posture-Adaptive Ferromagnetic Mousepad, focusing on the top surface and the surface finish 30. This view emphasizes the mousepad's upper surface Side A, which obscures the variable friction articulated arm (‘Magic Arm’) located below, highlighting the sleek and uninterrupted design of the top surface Side A. Although the specific material details and the microscopic texture of the surface finish 30 are not visible, it is meticulously engineered to optimize mouse tracking precision. The surface finish enhances pointer tracking and tactile response, ensuring durable and consistent performance. This arrangement is particularly effective for high-precision applications such as graphic design and detailed data manipulation, where smooth and accurate pointer movement is paramount.

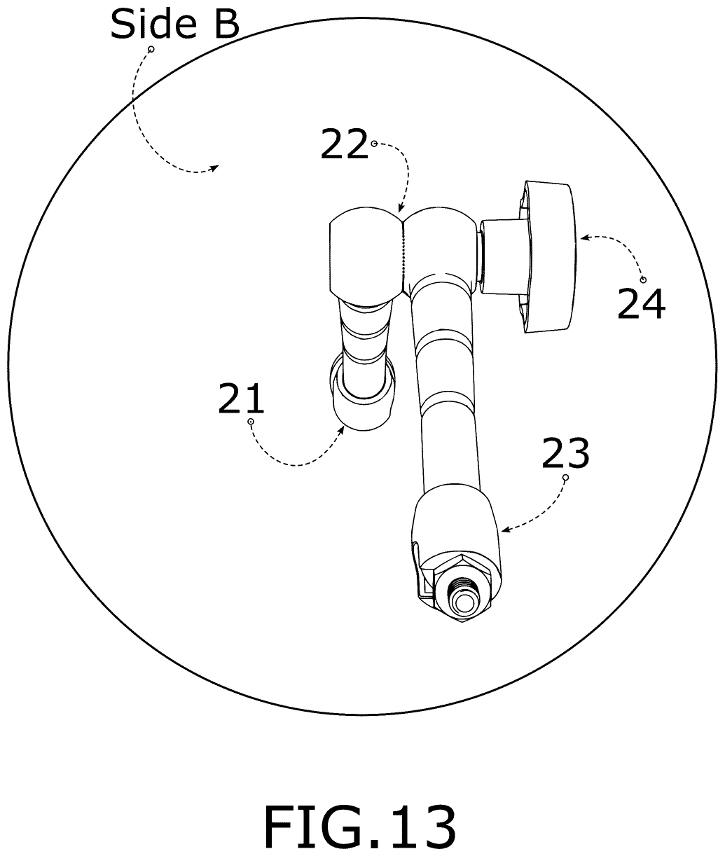

FIG. 13 provides a bottom perspective view of the second embodiment of the Posture-Adaptive Ferromagnetic Mousepad, illustrating the underside components of the variable friction articulated arm, known as the ‘Magic Arm’. This view reveals the wrist 21, elbow 22, friction control knob 24, and shoulder 23, each integral to the arm's functionality and ergonomic adjustability. The mounting hole, where one end of the Magic Arm is affixed, is obscured in this view, emphasizing the seamless integration of the arm into the mousepad's structure. This arrangement highlights the critical mechanical joints and adjustment mechanisms that enable precise control over the mousepad's positioning, enhancing the user's ability to customize their setup for optimal ergonomic comfort.

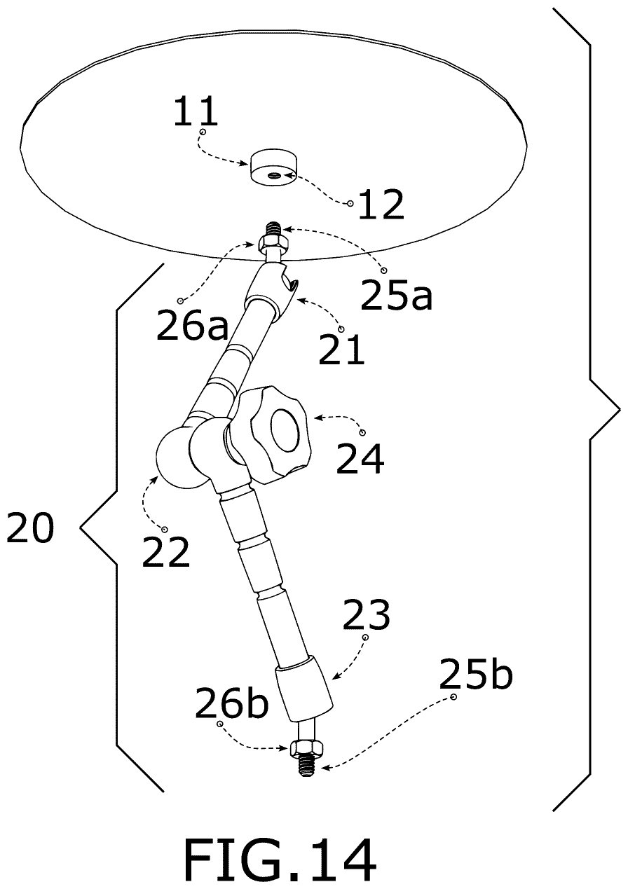

FIG. 14 provides an exploded view of the second embodiment of the Posture-Adaptive Ferromagnetic Mousepad, featuring the variable friction articulated arm (‘Magic Arm’) 20 detached for clarity. This depiction facilitates an understanding of how the Magic Arm 20 connects to the mousepad via the mounting hole 12.

### Key Components and Their Functions

Variable Friction Articulated Arm (‘Magic Arm’) 20: The Magic Arm 20 in this embodiment consists of several pivotal joints—including the wrist 21, elbow 22, and shoulder 23—that allow for extensive rotational and angular adjustments. These adjustments are critical for positioning the mousepad to meet specific ergonomic needs.

Friction Control Knob 24: The friction control knob 24 allows users to fine-tune the tension within the arm's joints. Adjusting this knob either secures the mousepad in a stable position or permits its repositioning, accommodating various user postures.

Connection Details: The Magic Arm 20 is shown detached from the mounting hole 12 to highlight how it connects to the mousepad through a standardized mounting hole 12 designed to accept a ¼ inch diameter by 20 threads per inch bolt (¼″-20 UNC) in this embodiment. This configuration ensures a secure and stable attachment, supporting the mousepad's weight and facilitating ergonomic adjustments.

### Assembly Considerations

Optional Washer: Although not depicted in this view, an optional washer or lock-washer can be used in conjunction with the mounting bolt 25a and nut 26a to enhance the load distribution and improve the stability of the connection. This detail, while omitted to visually maintain focus on the primary components, plays a role in ensuring the durability of the articulated arm's attachment under frequent use and adjustments.

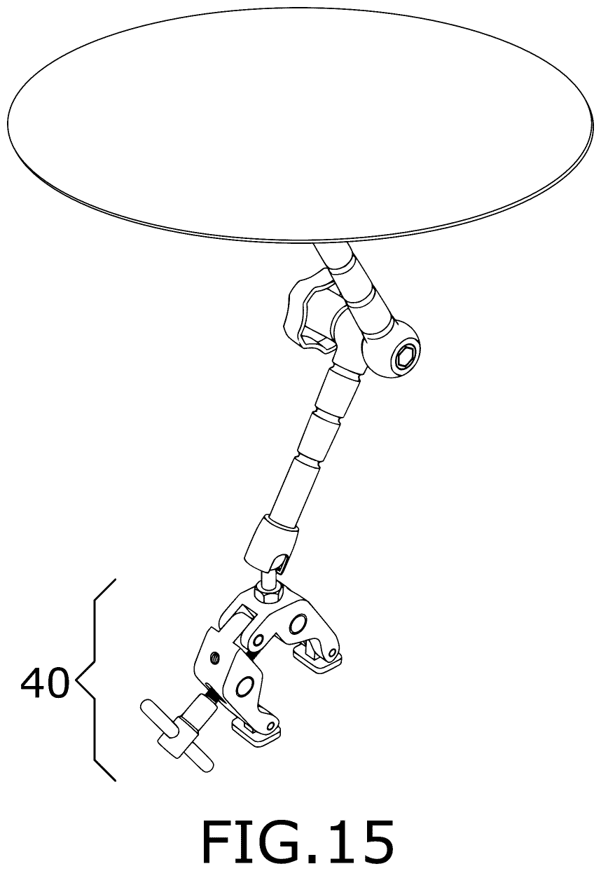

FIG. 15 illustrates a third embodiment of the Posture-Adaptive Ferromagnetic Mousepad, featuring the configuration previously shown in FIG. 6 now attached to a clamp 40. This clamp facilitates versatile mounting of the mousepad to various stable objects and furniture elements, such as the edges of desks or armrests of chairs. This flexibility allows the mousepad to be precisely positioned to accommodate the user's ergonomic needs during tasks that require accurate pointer tracking, such as in graphic design or intensive computing work. The clamp's 40 design ensures a secure hold, providing stability while allowing easy adjustments to the mousepad's location, thereby supporting optimal ergonomic posture and enhancing user comfort.

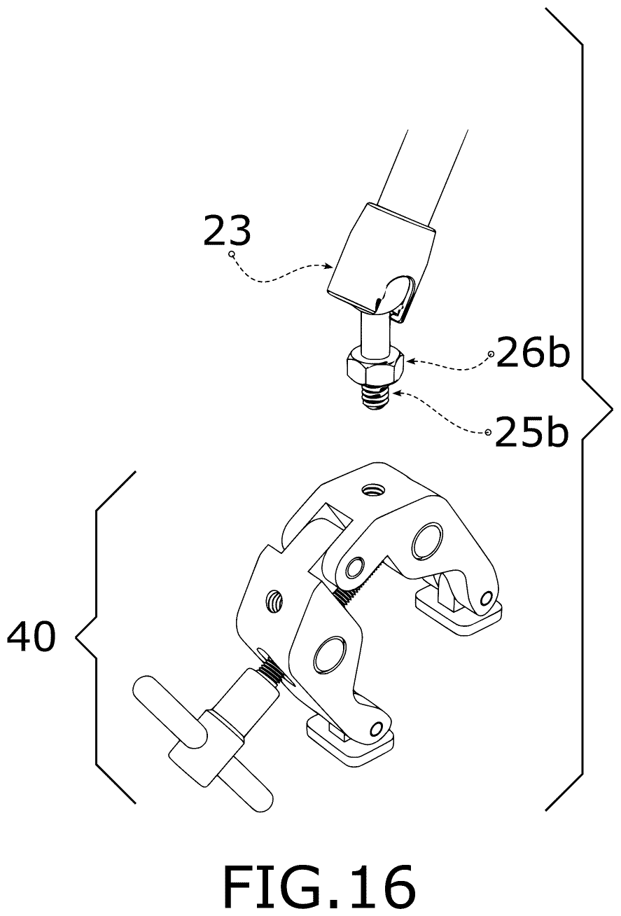

FIG. 16 provides an exploded close-up view detailing the connection of the Magic Arm's shoulder 23 to the clamp 40 in this third embodiment of the Posture-Adaptive Ferromagnetic Mousepad. The detailed illustration shows the nut 26b threaded onto the bolt 25b, which is then attached to the clamp 40. In this configuration, the bolt 25b and nut 26b function as a single cohesive unit, moving together when rotated to ensure a secure and unified assembly. Additionally, a threadlocker is applied to the bolt's 25b threads to enhance the connection's stability by preventing the nut 26b and bolt 25b from rotating or loosening after attachment to the clamp's 40 threaded hole. This application of threadlocker is critical for maintaining the rigidity and precision of the arm's positioning, especially in environments where the mousepad undergoes dynamic mouse tracking pressures and frequent adjustments. While in other applications a reversible and detachable connection might be preferred for flexibility, in this mousepad setup, the use of threadlocker ensures a strong bond that can withstand the forces exerted during the operation of a magnetized mouse, thus preventing any unintended movement or loosening of the components.

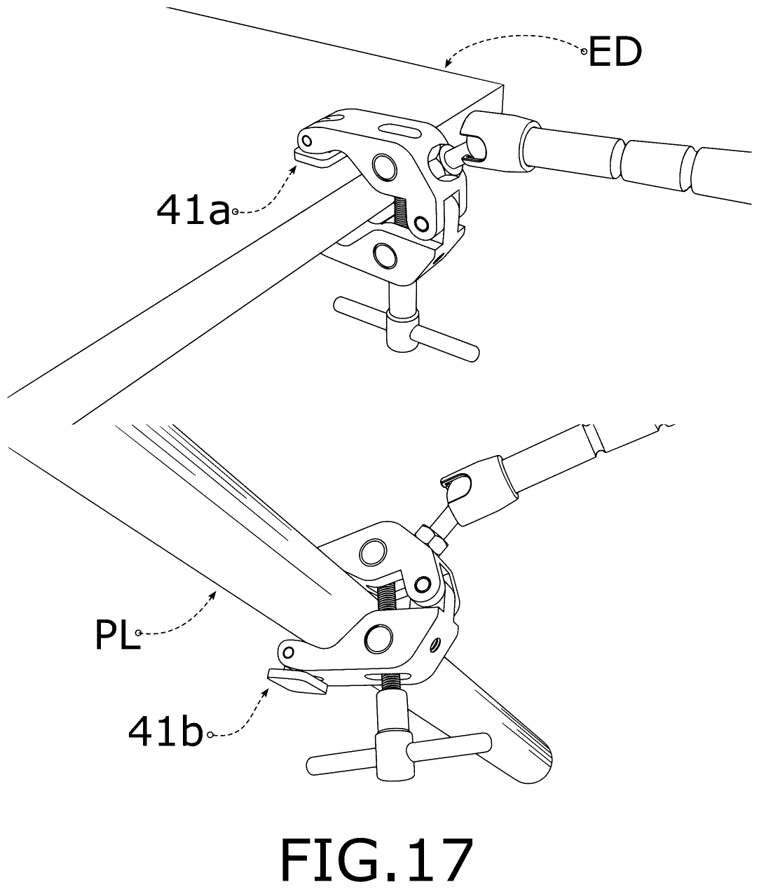

FIG. 17 presents an examination of the versatile mounting capabilities of the clamp used in the third embodiment of the Posture-Adaptive Ferromagnetic Mousepad. The first close-up view in this figure demonstrates the clamp securely attached to the edge of a desk ED, showcasing its ability to grip flat surfaces firmly and provide a stable and secure base for the mousepad. The second close-up view displays the clamp mounted on a rounded pole PL, emphasizing its flexible design that can conform to and firmly grasp cylindrical structures as well.

### Clamp Design and Functionality

Each view illustrates the mechanics of the clamp, including the pivoting grips 41a and 41b which are designed to accommodate various surface types. These grips can pivot to suit flat or contoured surfaces, ensuring a versatile and secure attachment regardless of the mounting environment. The clamp's robust design allows it to be easily and securely fastened, offering strong support and stability for the mousepad.

### Ergonomic and Practical Benefits

This flexible attachment capability of the clamp integration enhances the ergonomic setup by allowing users to position the mousepad in the most comfortable and practical location, whether at a traditional desk or on alternative structures like workshop rails or studio equipment. By facilitating easy adjustments and reliable positioning, the clamp helps maintain optimal ergonomic alignment, thereby reducing strain and increasing comfort during extended use.

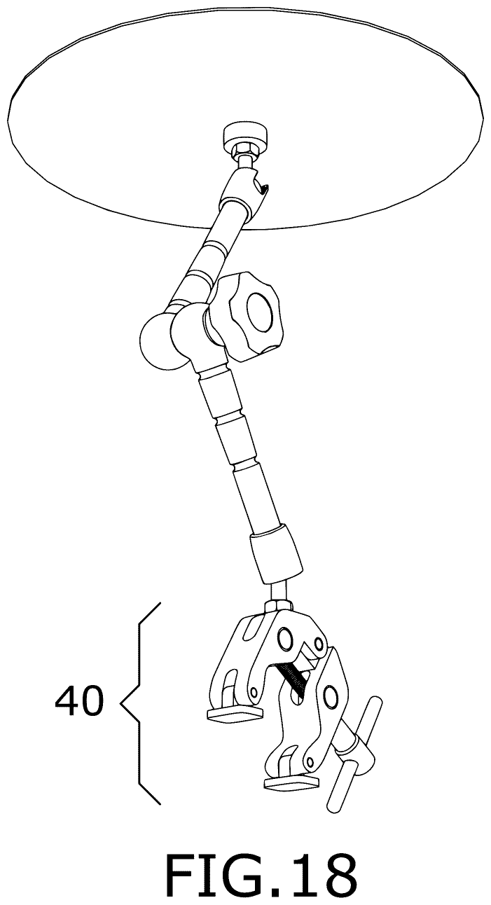

FIG. 18 displays a third embodiment of the Posture-Adaptive Ferromagnetic Mousepad, the same back-bottom-right perspective view of FIG. 7, attached to a clamp 40 as an integral part of its design. The clamp of this embodiment has an adjustable grip designed to attach to various types of furniture or stable surfaces, demonstrating the mousepad's versatility in different workspace environments. The inclusion of the clamp allows for robust and stable mounting, enabling the mousepad to be easily adjusted to the optimal location, height, and angle for user comfort and ergonomic alignment. This setup facilitates precise positioning adjustments to meet individual user preferences, supporting ergonomic setups that reduce strain during extended use.

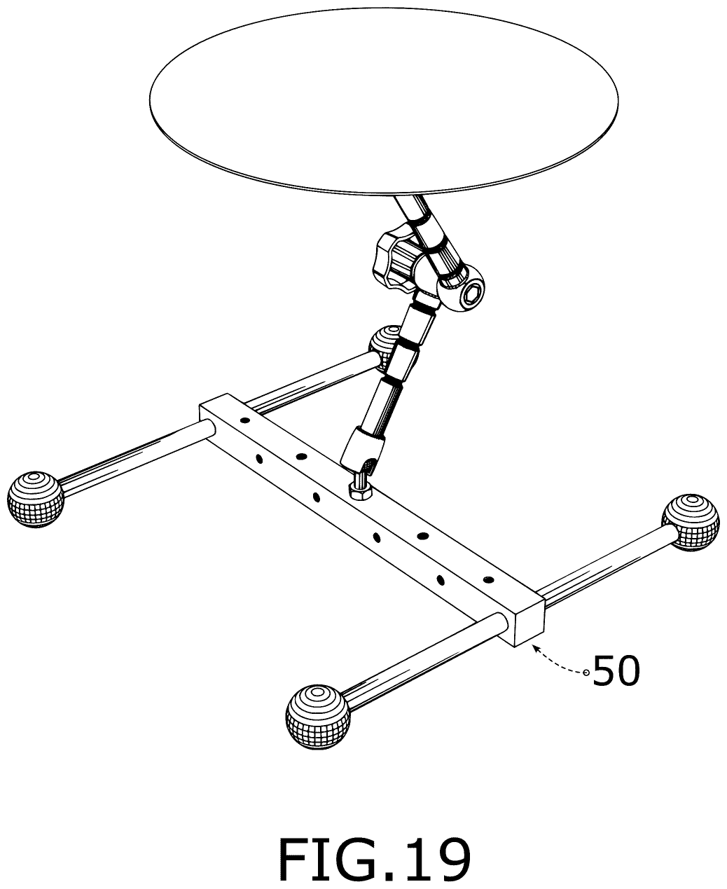

FIG. 19 illustrates the Posture-Adaptive Ferromagnetic Mousepad, featuring the embodiment previously shown in FIG. 6 now mounted on a stand 50. This configuration highlights the mousepad's adaptability to different positioning options provided by the stand, facilitating optimal height and angle adjustments for ergonomic user interaction. The stand offers a stable and adjustable platform, enhancing the mousepad's utility in varied work environments where desk space may be limited or where supporting the mousepad by a flat surface such as on a desk is required.

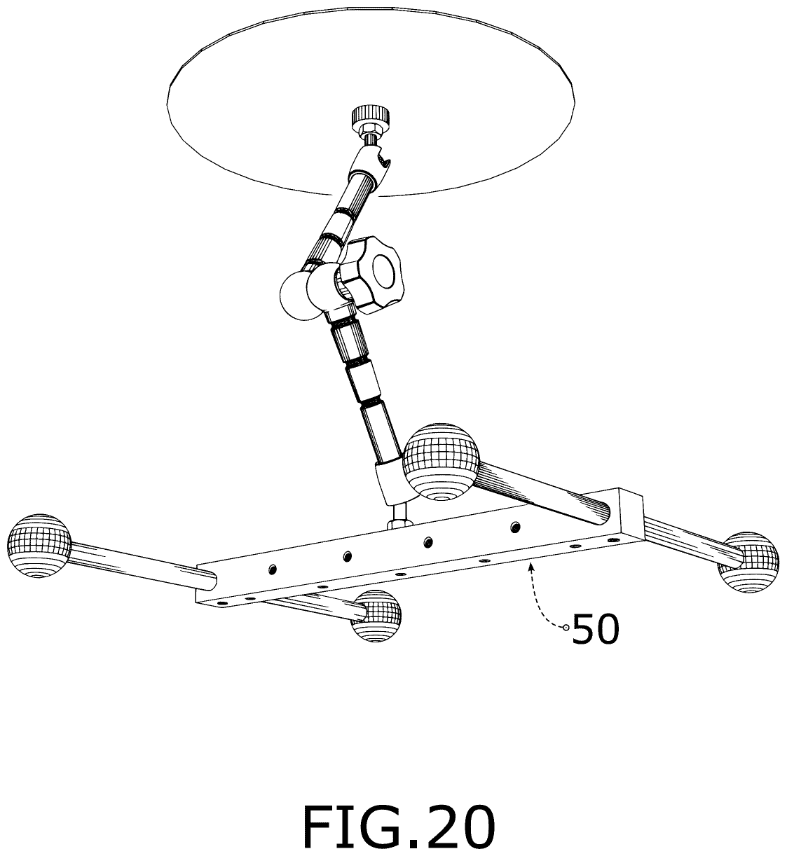

FIG. 20 illustrates the Posture-Adaptive Ferromagnetic Mousepad, as previously seen in FIG. 7, securely mounted on a stand 50. This configuration highlights the stand's four spherically shaped feet, which provide enhanced stability and balance, ensuring the mousepad remains steady during use. The feet of this stand 50 are made of silicone, but may be made of other materials.

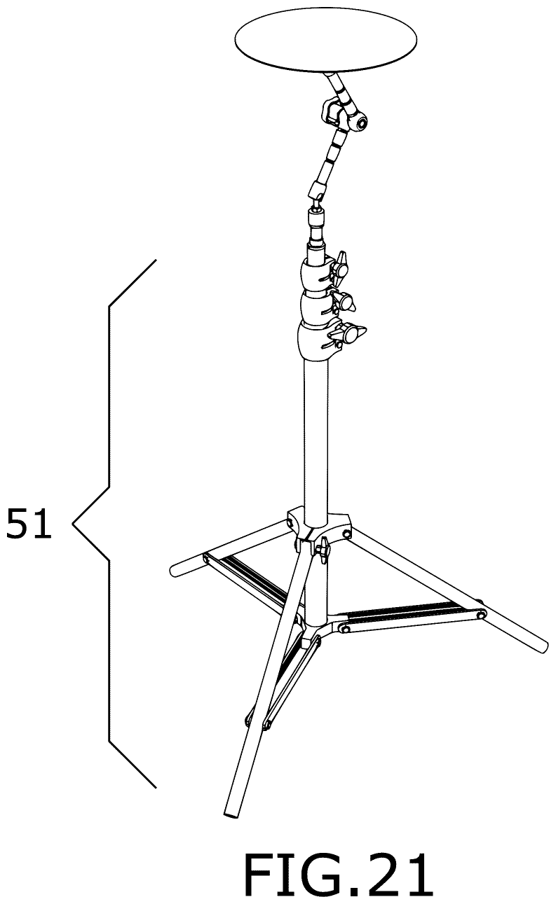

FIG. 21 illustrates the Posture-Adaptive Ferromagnetic Mousepad, utilizing the embodiment previously shown in FIG. 6, now mounted on an extendable stand 51 as another form of supporting structure. This stand 51, commonly employed in the photography equipment industry for its versatility, features multiple telescoping poles that allow for user-adjustable height. The desired position is secured using friction control knobs located at the top end of each pole, providing precise control over the stand's height and stability. This configuration offers flexible positioning of the mousepad, enhancing ergonomic comfort by allowing users to adjust the height to suit their specific workplace ergonomics.

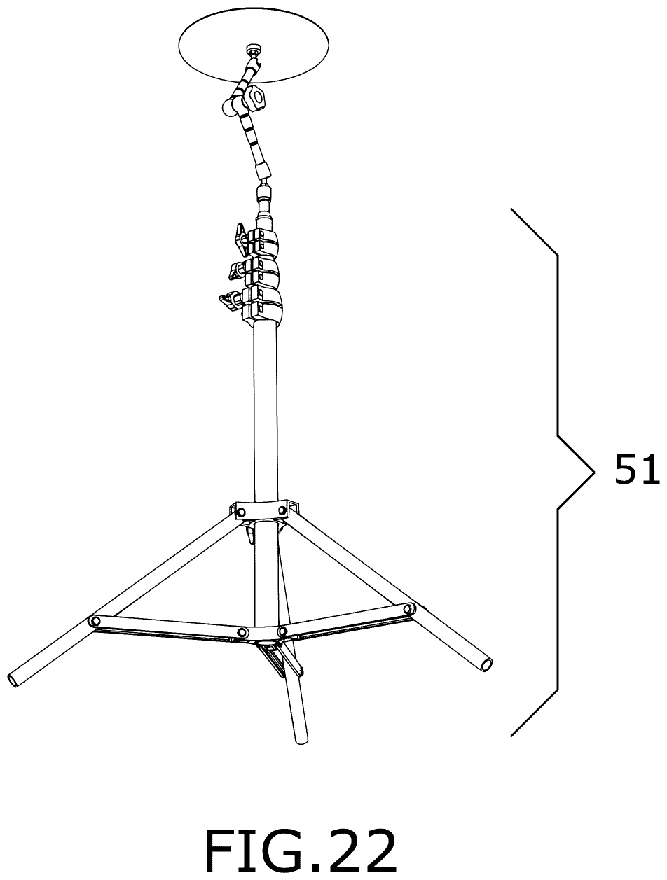

FIG. 22 depicts another view of the Posture-Adaptive Ferromagnetic Mousepad attached to a supporting structure. This time showing the embodiment from FIG. 7 mounted on an extendable stand 51. This perspective continues to highlight the versatility and ergonomic benefits of using an extendable stand 51, which allows for customizable height adjustments to accommodate various user preferences and workplace setups. The extendable stand ensures that the mousepad remains at an optimal height and angle for ergonomic comfort and functionality.

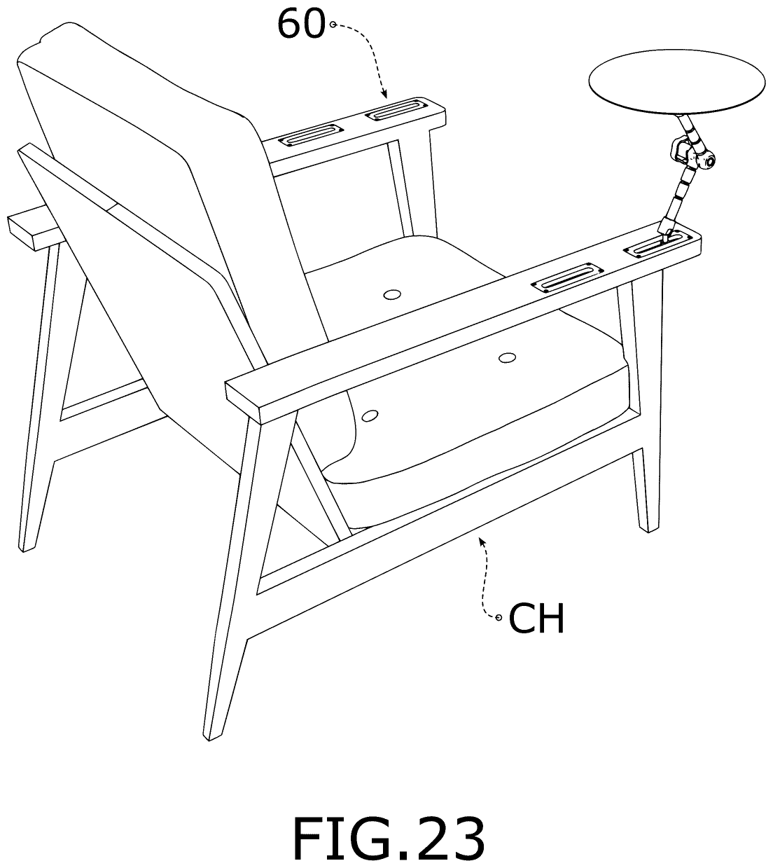

FIG. 23 illustrates a fourth embodiment of the Posture-Adaptive Ferromagnetic Mousepad, featuring the assembly of FIG. 6 now integrating a fixture-track 60 configured for attachment to furniture surfaces such as a chair CH. This assembly demonstrates the mousepad's adaptability by mounting directly to furniture via its integrated fixture-track 60, which allows for extremely close positioning relative to the user's natural arm reach while seated. This setup maximizes ergonomic benefits by aligning the mousepad position with the user's hand placement when using the mouse, reducing the need for excessive arm extension or awkward postures. The fixture-track 60 system ensures that the mousepad can be adjusted easily and secured firmly, providing stable support even during extended use.

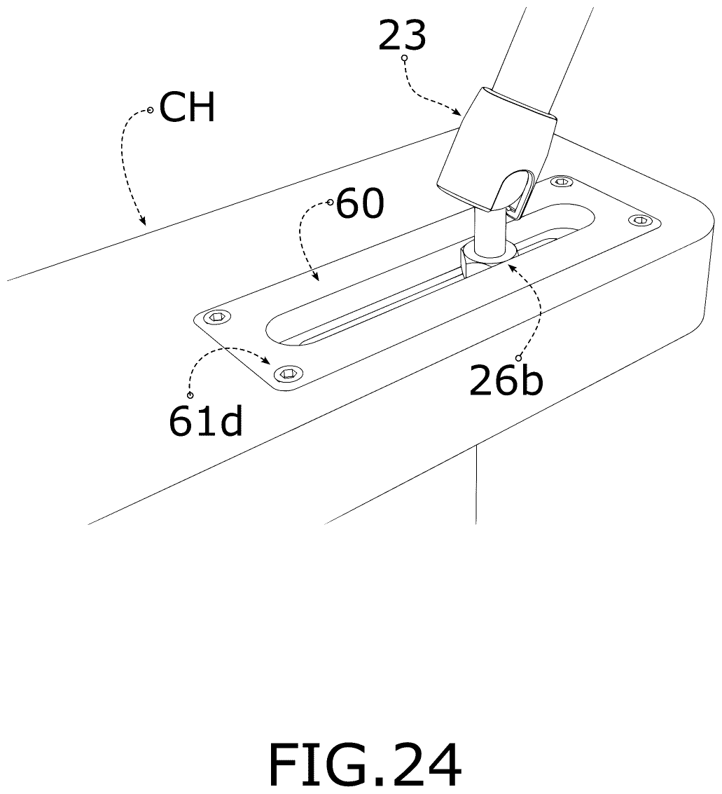

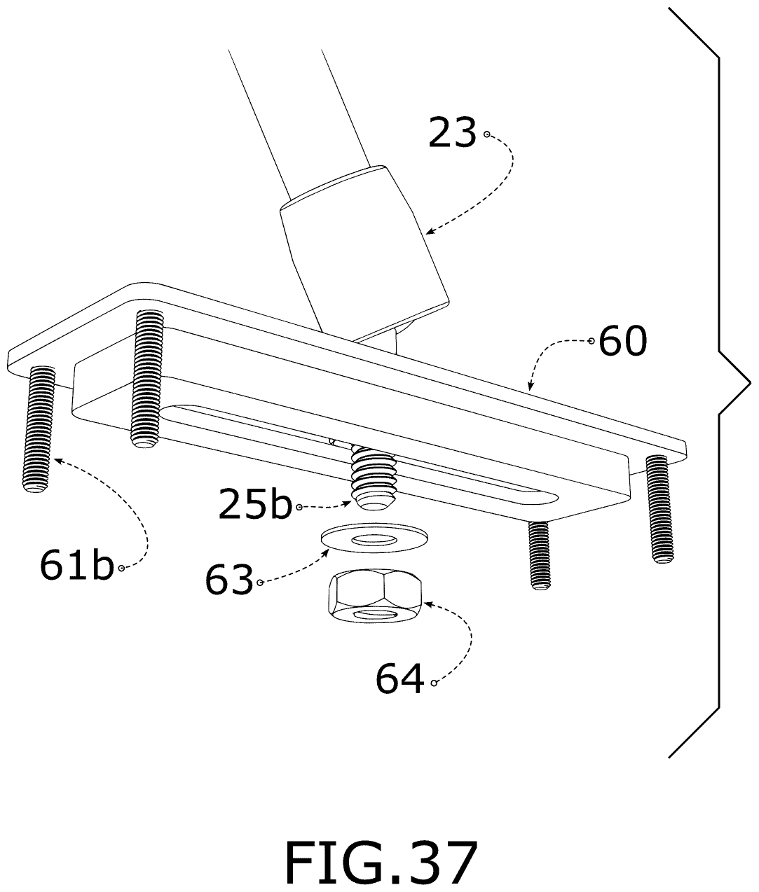

FIG. 24 offers a detailed close-up view of the fixture-track 60 attachment system of the Posture-Adaptive Ferromagnetic Mousepad, as seen in the previous FIG. 23 setup. This view focuses on how the Magic Arm's shoulder 23 connects to the fixture-track 60 configured for attaching to a chair CH. The image clearly shows the fasteners and particularly the fourth fastener 61d that helps secure the fixture-track to a chair. Additionally, it illustrates how the nut 26b is prevented from turning within the fixture-track 60 which is critical for maintaining the stability of the mousepad once positioned. An additional nut as indicated in FIG. 37, is employed at the end of the distal bolt to enhance the attachment of the shoulder 23 to the fixture-track 60, further ensuring that the mousepad assembly remains securely in place under various usage conditions.

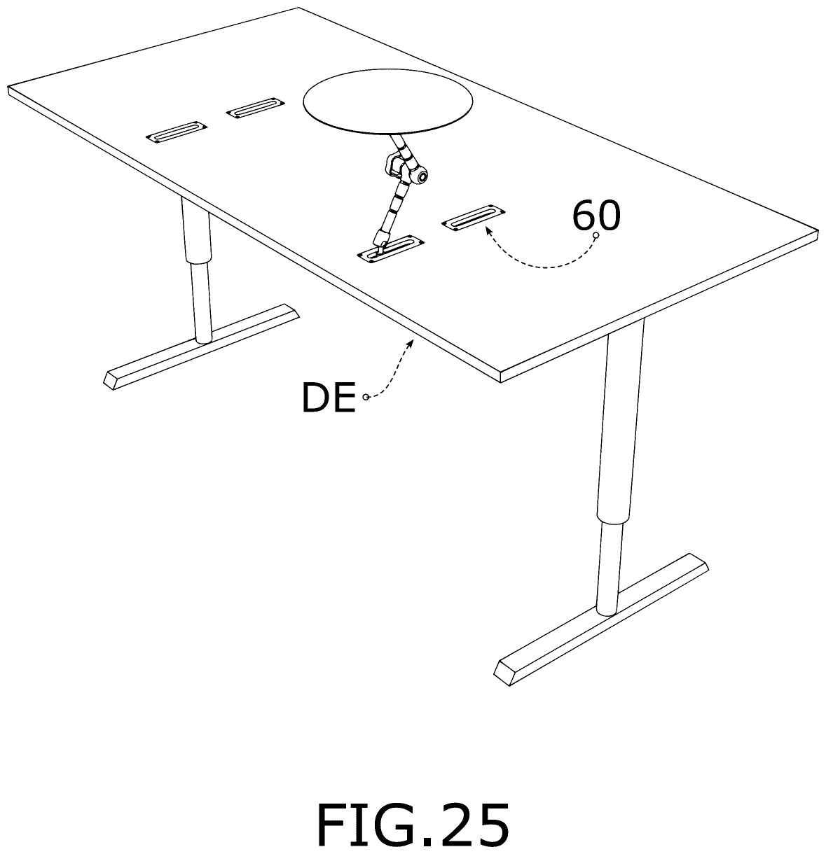

FIG. 25 depicts the fourth embodiment of a Posture-Adaptive Ferromagnetic Mousepad, featuring the setup from FIG. 6 with an integrated fixture-track 60 now attached to a desk DE. This illustration showcases the mousepad's adaptability to desk environments, leveraging the fixture-track 60 system to provide a secure and adjustable mounting solution. By attaching to the surface of a desk, the mousepad can be easily positioned at the optimal location and height for the user, enhancing ergonomic comfort and accessibility during use. The design ensures that the mousepad remains stable and accessible, allowing for adjustments that accommodate various user preferences and workspace requirements.

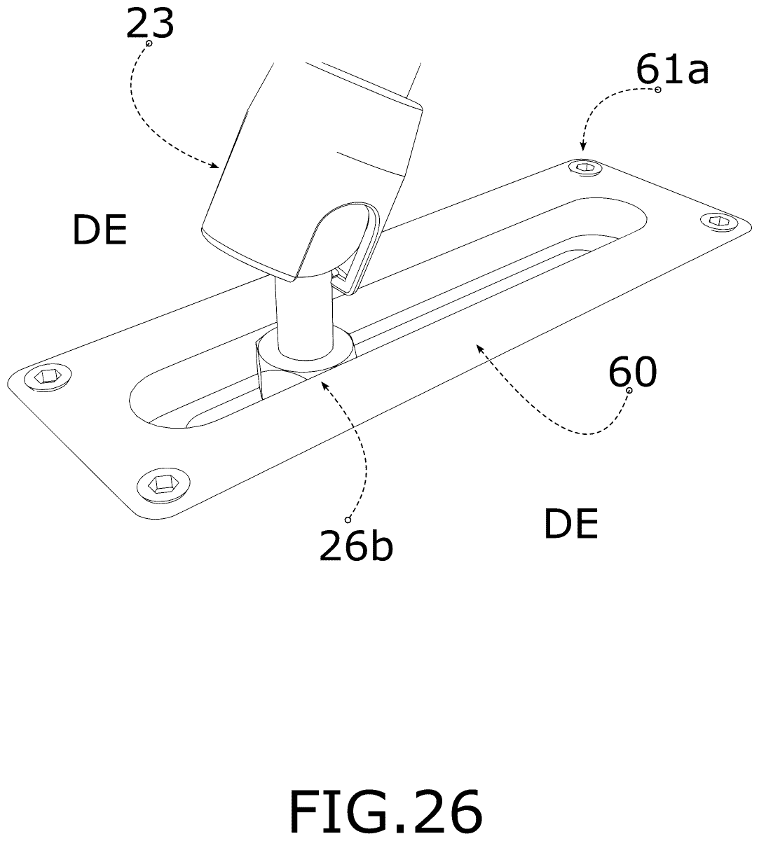

FIG. 26 provides a detailed close-up view of the integrated fixture-track 60 mounting system employed in the fourth embodiment of the Posture-Adaptive Ferromagnetic Mousepad, as illustrated previously in FIG. 25. This figure highlights the connection of the Magic Arm's shoulder 23 to the fixture-track 60 on a desk DE. The image showcases the top of the fasteners and particularly the top left fastener 61a for anchoring the fixture-track 60 securely to the desk. It also details how the fixture-track 60 design prevents the nut 26b from rotating, which is essential for maintaining the stability and position of the mousepad once set. An additional nut which will be shown in FIG. 37, is employed at the end of the bolt to reinforce the connection between the shoulder 23 and the fixture-track 60, ensuring robust attachment and reliable support under various mounting conditions, such as attaching to furniture.

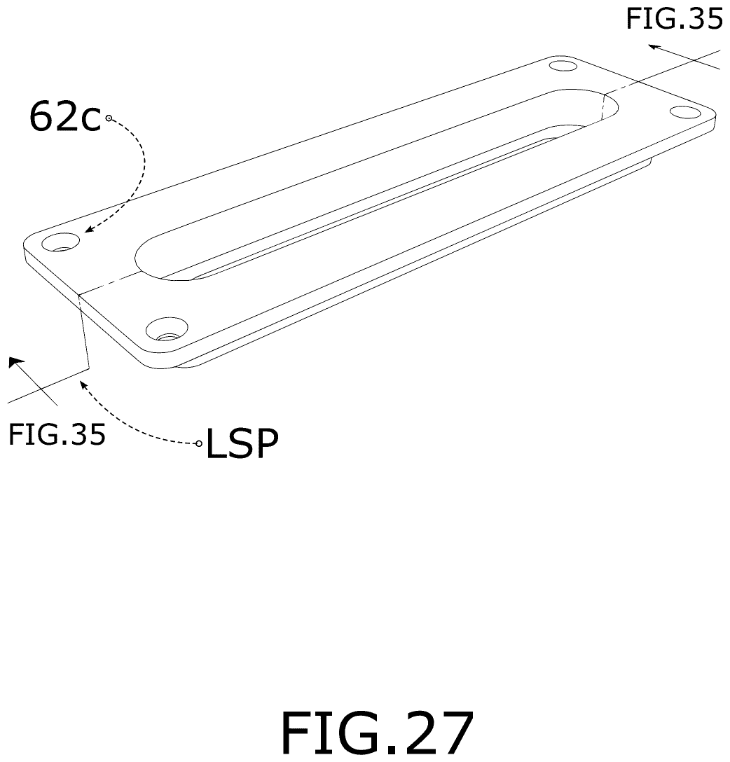

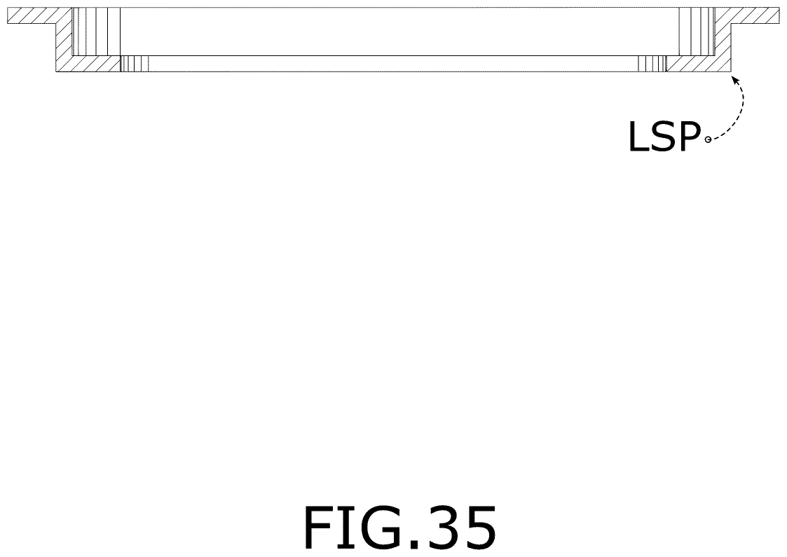

FIG. 27 is a front-top-left perspective view of a fixture-track, fastener holes, particularly the far left fastener hole 62c, and a length cross-section plane LSP referenced in FIG. 35;

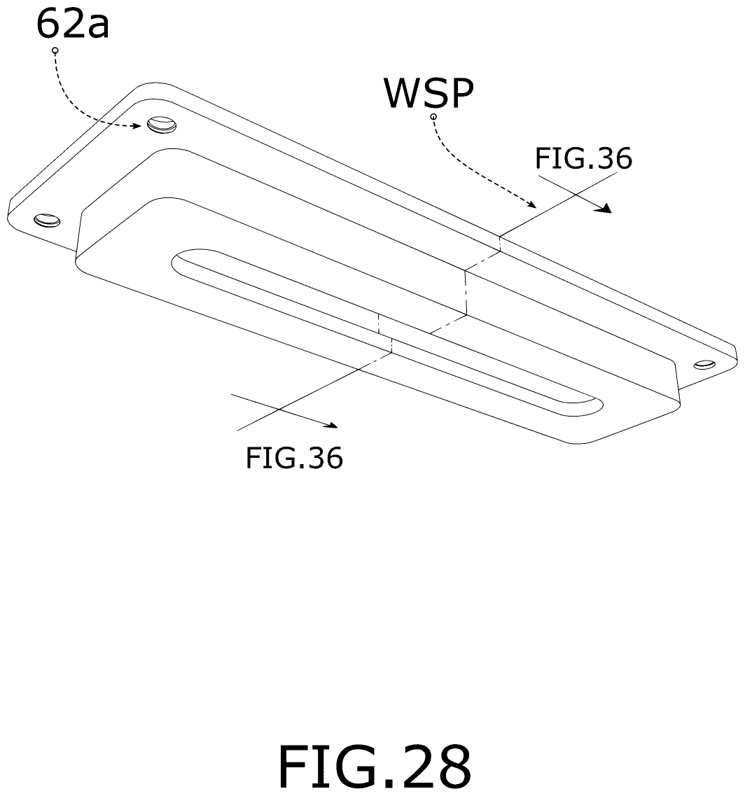

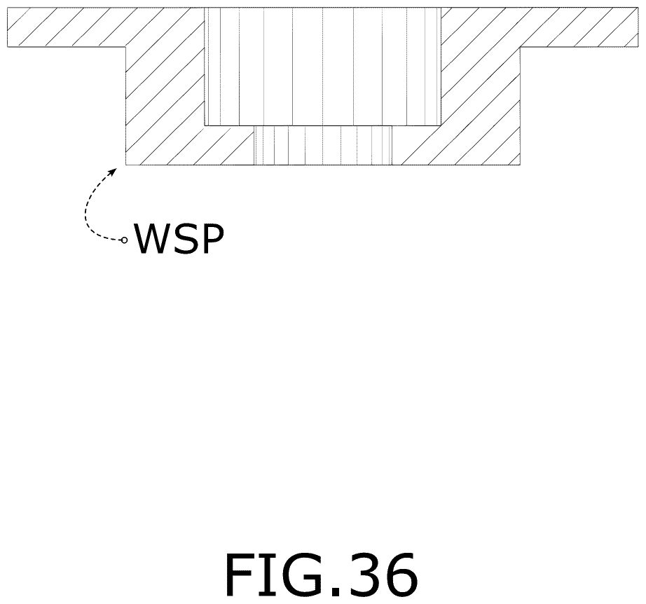

FIG. 28 is a back-bottom-right perspective view of a fixture-track, fastener holes, particularly fastener hole 62a, and a width cross-section plane WSP referenced in FIG. 36;

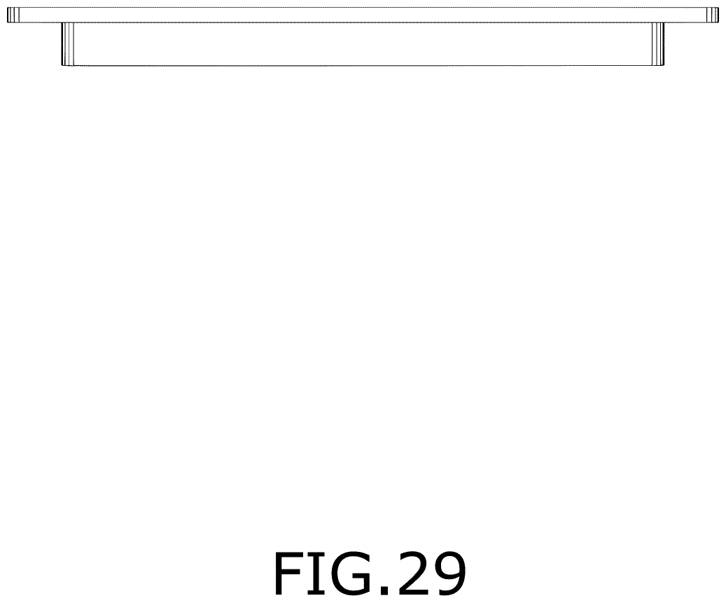

FIG. 29 is a left perspective view thereof;

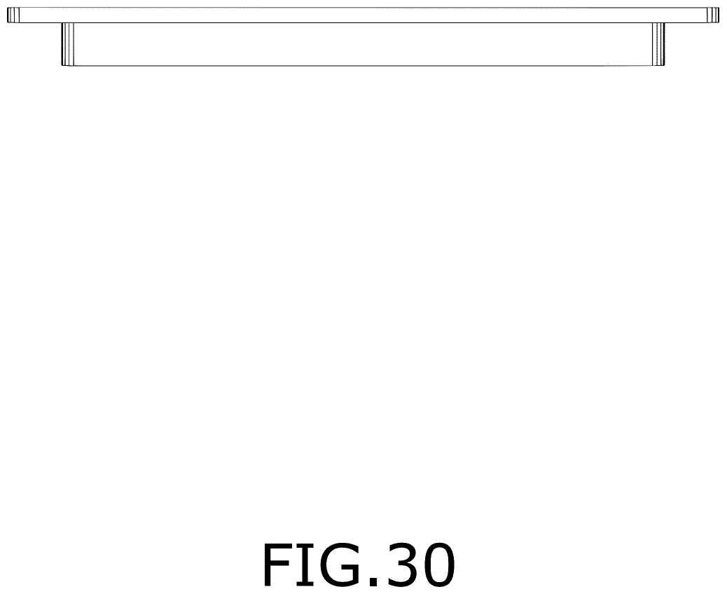

FIG. 30 is a right perspective view thereof;

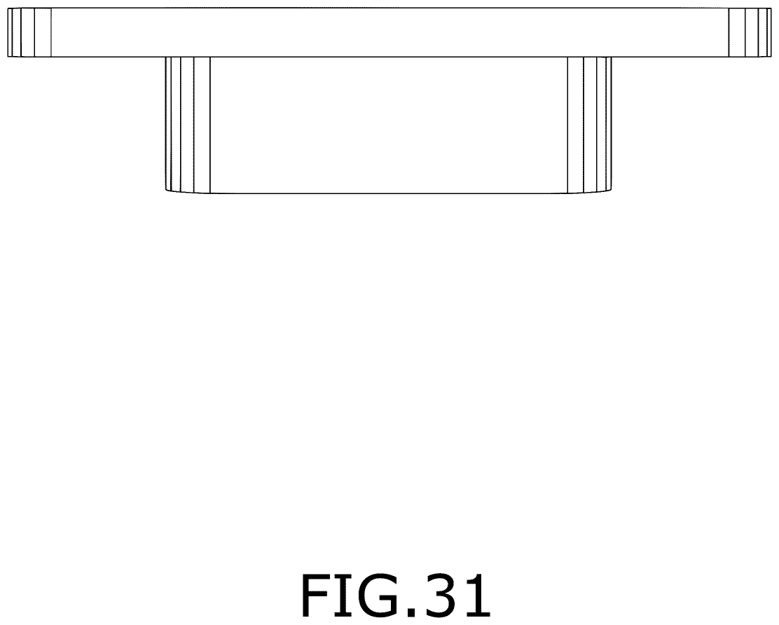

FIG. 31 is a front perspective view thereof;

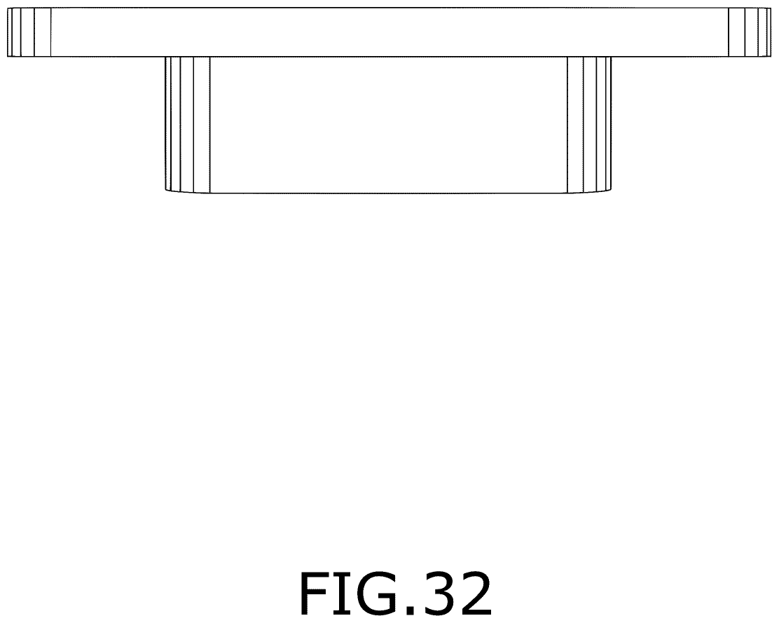

FIG. 32 is a back perspective view thereof;

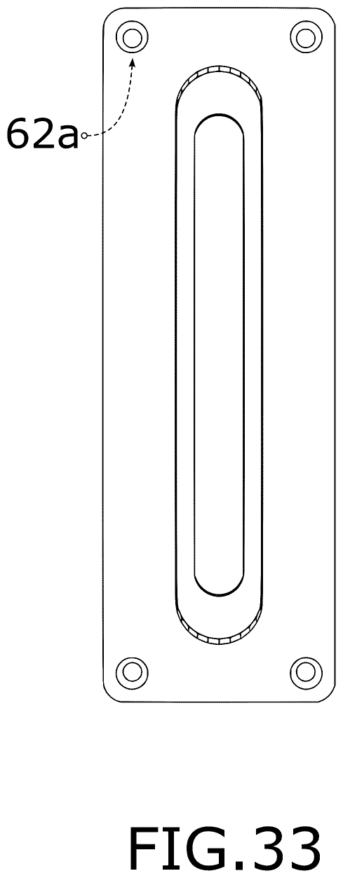

FIG. 33 is a top perspective view thereof showing fastener holes, and particularly fastener hole 62a;

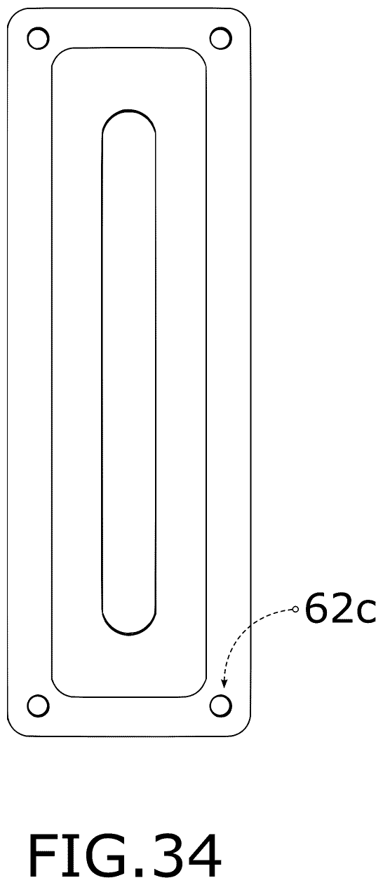

FIG. 34 is a bottom perspective view thereof showing fastener holes, and particularly fastener hole 62c;

FIG. 35 is an orthographic view along the length cross-section plane LSP of FIG. 27 with diagonal-parallel lines indicating the length cross-section plane LSP; and

FIG. 36 is an orthographic view along the cross-section plane WSP of FIG. 28 with diagonal-parallel lines indicating the width cross-section plane WSP.

FIG. 37 is a back-bottom-right exploded perspective view of a fixture-track FT where a Posture-Adaptive Ferromagnetic Mousepad magic arm shoulder 23 is attached showing a magic arm bolt 25b, an optional washer 63, additional nut 64, bottom of the fasteners, particularly fastener 61b, fixture-track 60, and magic arm shoulder 23.

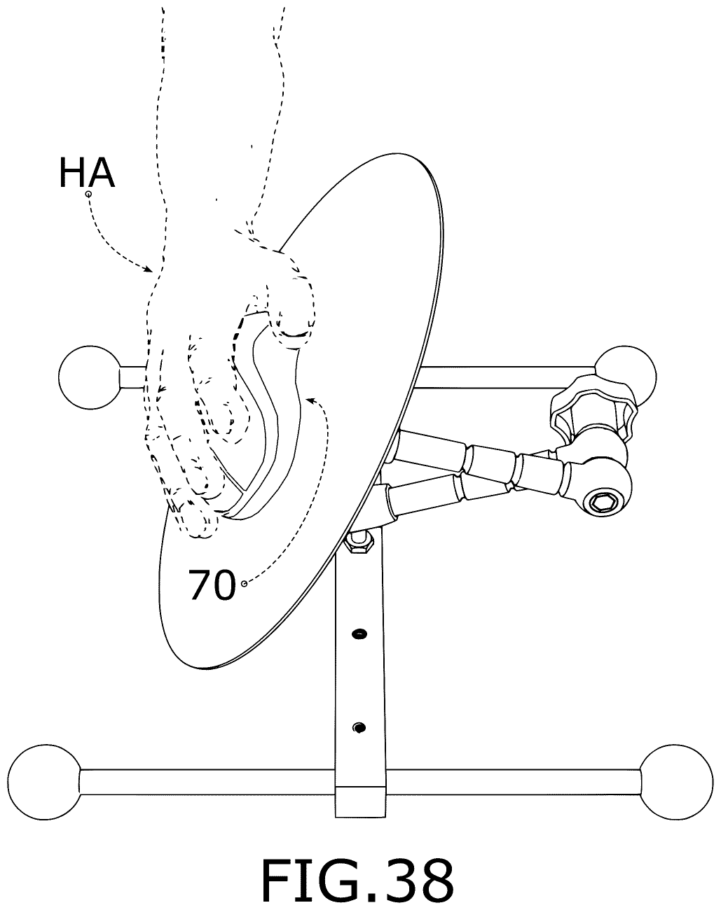

FIG. 38 presents an illustration of the Posture-Adaptive Ferromagnetic Mousepad in action, depicted from a left elevation perspective of the mousepad attached to a stand within a typical usage environment. This view features an operating hand HA and a wireless magnetized mouse 70, with the hand HA drawn in broken lines to indicate an obvious environmental structure. This image emphasizes how the mousepad supports the mouse 70 and hand HA in an ergonomic position, enhancing user comfort and ergonomic posture during operation.

The design of the mousepad is specifically tailored for use with a magnetized mouse, ensuring that the mouse adheres securely to the mousepad after dynamic tracking movements. This magnetic adherence is crucial as it allows the mouse to remain in a user-defined ergonomic position, ready for continued use without the risk of falling. This feature significantly reduces strain on the user's hand and wrist, aligning with ergonomic principles aimed at preventing repetitive stress injuries. The elevation view also highlights the adjustable tilt of the mousepad, enabling users to fine-tune the angle for a more posture-neutral position, thereby optimizing wrist alignment and enhancing comfort during extended periods of use.

This depiction is crucial for demonstrating the ergonomic benefits and practical utility of the mousepad, illustrating how it seamlessly integrates into a user's computing environment and actively contributes to maintaining healthful postures during use.

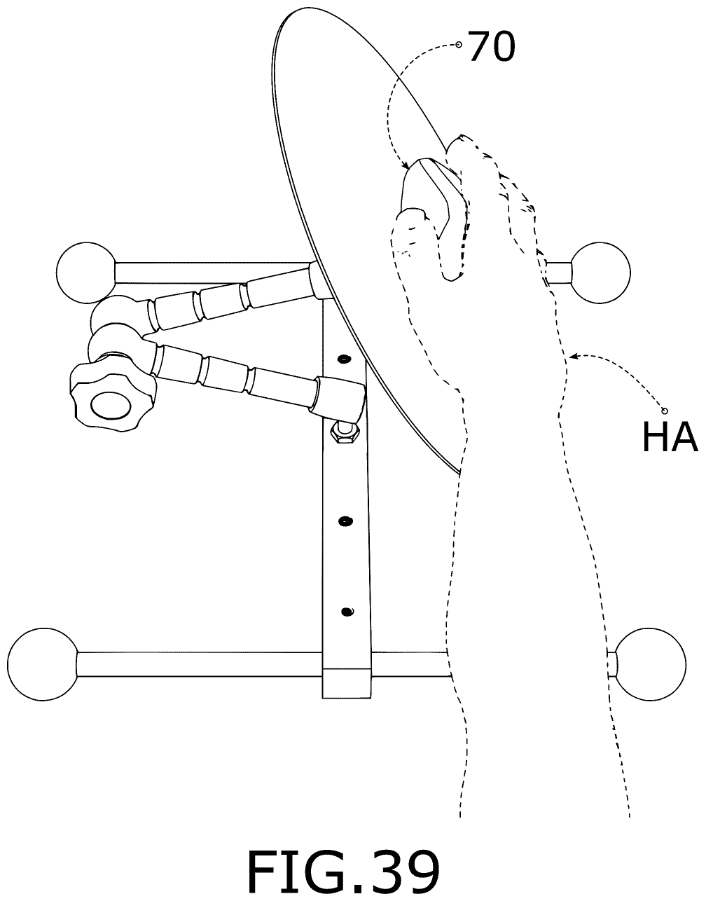

FIG. 39 presents a right elevation perspective of the Posture-Adaptive Ferromagnetic Mousepad, as seen within the same typical usage environment previously explored in FIG. 38. This illustration includes an operating hand HA depicted in broken lines as an environmental structure, and a wireless magnetized mouse 70. This view serves as a complement to FIG. 38 by offering an alternative perspective. It effectively represents a user's point-of-view (POV) when using their right hand to operate the mouse 70 on the mousepad. This perspective demonstrates how the mousepad's design facilitates ergonomic interaction, aligning seamlessly with a user's neutral hand posture and positioning within a computing setup.

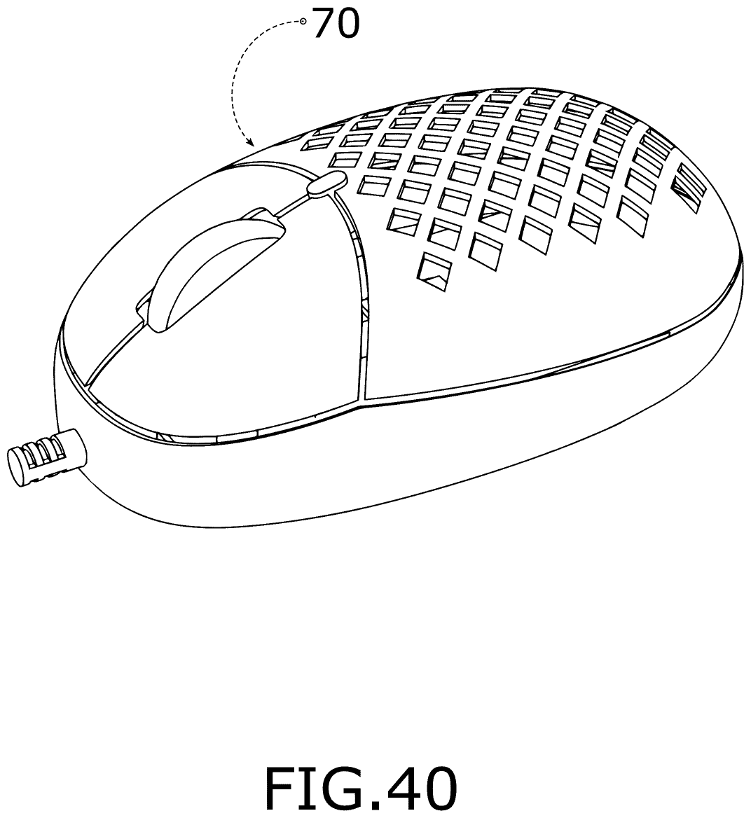

FIG. 40 presents a front-top-left perspective view of a magnetized computer mouse 70, designed for use with the Posture-Adaptive Ferromagnetic Mousepad. This configuration includes two strategically placed permanent magnets within the base floor to achieve a balanced magnetic cling force with the mousepad's ferromagnetic surface. These magnets are positioned to optimize the balance between magnetic attraction and friction, ensuring smooth and controlled mouse movement. The lightweight design of the mouse body, optimized at 70 grams or less, is crucial as it requires smaller, less powerful magnets, which are sufficient to maintain stability without compromising ease of movement. Heavier mice, exceeding 70 grams, would necessitate larger magnets, potentially increasing friction and making mouse movement more laborious. This weight specification refers to the mouse body alone, excluding the weight of any attached cord, which can weigh an additional 30 to 40 grams, potentially bringing the total weight to around 110 grams for wired mice. This mouse functions effectively with a single magnet but can accommodate multiple magnets to enhance performance based on user preference. Like standard mice, this magnetized variant maintains all typical functionalities but with added magnetic properties to optimize interaction with the Posture-Adaptive Ferromagnetic Mousepad.

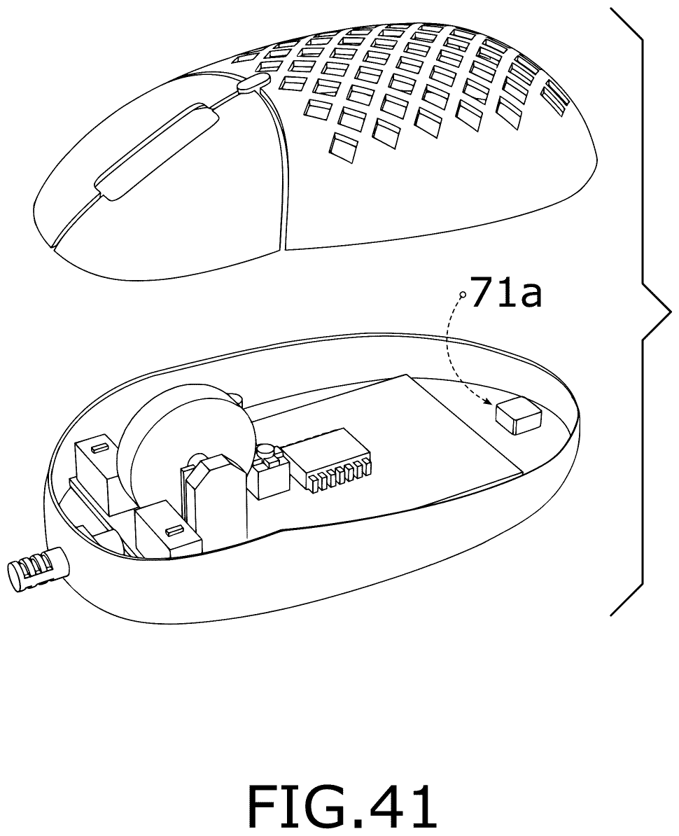

FIG. 41 provides an exploded view of the magnetized mouse previously seen in FIG. 40, specifically illustrating the attachment of a rear permanent magnet 71a within the base of the mouse enclosure. An adhesive bonding the magnet to the mouse base floor has been found to work well for securing the magnet 71a. This view details the precise location and integration of the magnet, which is crucial for maintaining the mouse's stability and magnetic interaction with the Posture-Adaptive Ferromagnetic Mousepad. All typical mouse components are not depicted in full detail as the focus here is on showcasing how the rear magnet is situated to enhance the magnetic functionality without altering the standard operation of the mouse.

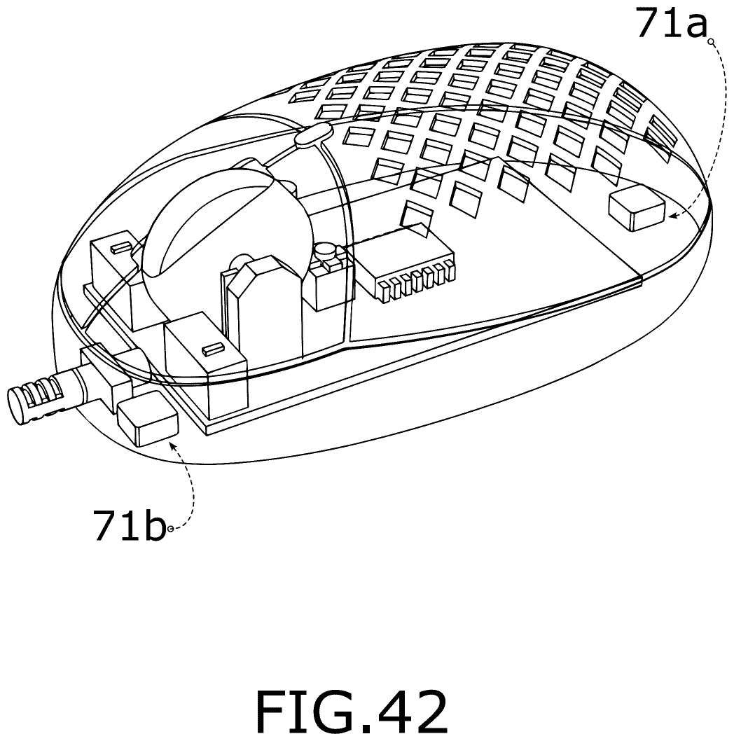

FIG. 42 offers a view of the magnetized computer mouse, as previously introduced in FIG. 40, featuring an optically transparent enclosure to clearly demonstrate the placement of the front permanent magnet 71b on the base floor of the mouse. This figure also reiterates the location of the rear permanent magnet 71a, providing a complete overview of the magnetic configuration that facilitates the mouse's interaction with the Posture-Adaptive Ferromagnetic Mousepad. The transparent enclosure serves to highlight the internal arrangement of magnets, showing how both the front and rear magnets are positioned to optimize the magnetic balance and ensure smooth, stable tracking on the Posture-Adaptive Ferromagnetic Mousepad surface.

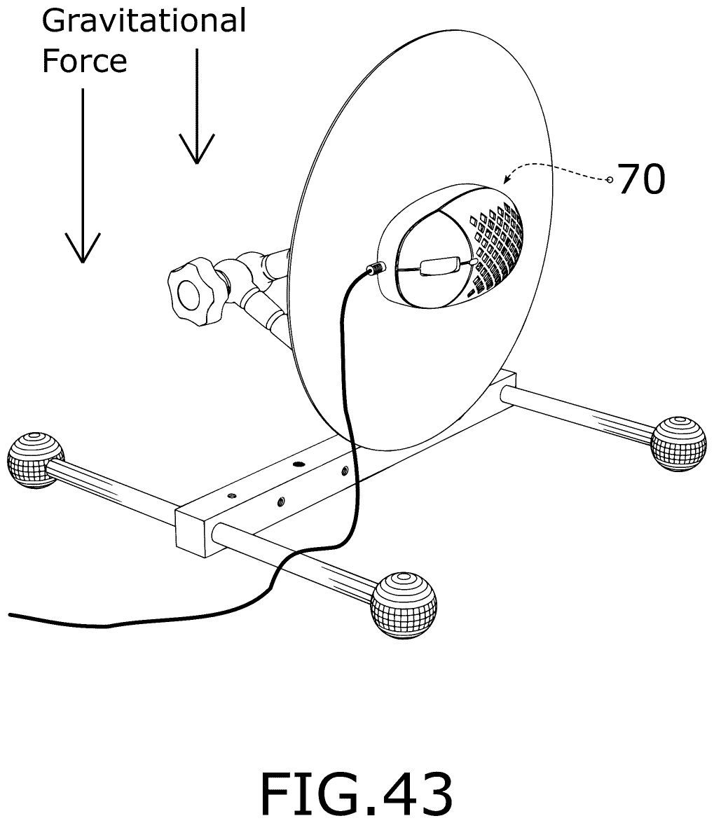

FIG. 43 demonstrates a front-top-right view of the Posture-Adaptive Ferromagnetic Mousepad mounted on a stand, uniquely positioned with its tracking surface tilted 90 degrees from a horizontal position. This figure features a wired magnetized computer mouse 70 maintaining its position on the mousepad's surface, despite the extreme tilt and opposing gravitational force. The mouse clings securely, illustrating the effective magnetic interaction between the mouse and the ferromagnetic surface of the mousepad. This setup visually confirms the mousepad's capability to support the mouse in any orientation, showcasing its utility in environments where space constraints or unique ergonomic setups are required.

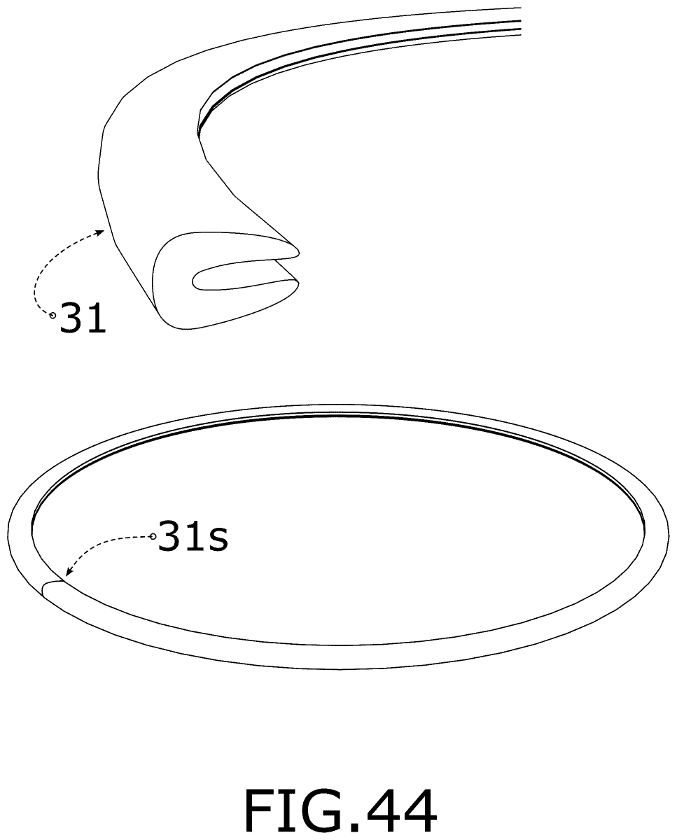

FIG. 44 presents an additional component to the Posture-Adaptive Ferromagnetic Mousepad, focusing on the innovative integration of a rubberized trim. Silicone, or other rubber-like materials can be used for the same purpose. The rubber trim is not depicted in other figure drawings to ensure the edges of the planar body are clearly visible, maintaining focus on the structure and design of the mousepad without obscuration. The top image depicts a close up of the trim 31, which is used to wrap around the edge of the mousepad's planar body. The image below illustrates how the trim wraps the edges of the planar body forming a seam 31s where the trim begins and terminates. This trim is crafted from a soft rubber material designed to address multiple functionalities: Firstly, it serves as a protective barrier, preventing user discomfort or injury from the potentially sharp edges of the metal planar body. Secondly, it enhances the aesthetic appeal of the mousepad by providing a polished finish to the edge. Lastly, the rubberized trim acts functionally as a ridge. This ridge is strategically implemented to allow the magnetized mouse to detect the edge of the mousepad during tracking movements. When the mouse approaches the edge, it encounters this ridge, which serves as a tactile boundary that prevents the mouse from slipping off the pad, thereby enhancing user control and safety during use.

Many modifications and variations may of course be devised given the above description of preferred embodiments for implementing the principles in the present disclosure. It is intended that all such modifications and variations be considered as within the spirit and scope of this disclosure, as defined in the following claims.

1. An ergonomic computer mousepad, comprising:
a planar body constructed from ferromagnetic material;
an integrated mounting mechanism designed for attachment to a variety of supporting structures; and
a surface finish engineered for compatibility with magnetized computer mice, wherein said surface facilitates uninterrupted adherence of a magnetized mouse during both dynamic tracking movements and stationary periods.

2. The mousepad of claim 1, wherein the mounting mechanism comprises a mounting structure adhered to the planar body with an integrated threaded hole configured to accommodate a mounting bolt of any size.

3. The mousepad of claim 1, wherein the integrated mounting mechanism comprises a mounting structure adhered to the planar body with an integrated threaded hole configured to accommodate a mounting bolt of ¼ inch diameter by 20 threads per inch (¼″-20 UNC) specification.

4. The mousepad of claim 1, further comprising a trim made of rubber, silicone, or other rubber-like materials that wraps around the edges of the planar body.

5. An ergonomic computer mousepad, comprising:
a planar body constructed from ferromagnetic material;
an integrated mounting mechanism designed for attachment to a variety of supporting structures;
an articulating assembly attached to the integrated mounting mechanism, and
a surface finish engineered for compatibility with magnetized computer mice, wherein said surface facilitates uninterrupted adherence of a magnetized mouse during both dynamic tracking movements and stationary periods.

6. The mousepad of claim 5, wherein the articulating assembly is a variable friction articulated arm.

7. The mousepad of claim 5, wherein the articulating assembly includes a terminal attachment feature at its distal end, such as a clamp, magnet, suction device, or other securing mechanism, configured for reversible and secure engagement with a variety of surfaces and structural elements.

8. The mousepad of claim 5, wherein the articulating assembly is a variable friction articulated arm including a terminal attachment feature at its distal end, such as a clamp, magnet, suction device, or other securing mechanism, configured for reversible and secure engagement with a variety of surfaces and structural elements.

9. The mousepad of claim 5, further including a stand configured to support the mousepad in a raised position relative to a support surface.

10. The mousepad of claim 5, further including an extendable stand configured to support the mousepad in a raised position relative to a support surface.

11. The mousepad of claim 5, wherein the distal end or shoulder of the articulating assembly is attached to a fixture-track.

12. The mousepad of claim 5, wherein the articulating assembly is a variable friction articulated arm attached to a fixture-track.

13. The mousepad of claim 5, further comprising a trim made of rubber, silicone, or other rubber-like materials that wraps around the edges of the planar body.

14. A magnetized computer mouse, comprising:
an enclosure;
one or more permanent magnets integrated in or on said enclosure;
wherein the overall weight of the mouse body is 70 grams or less.

15. The magnetized mouse of claim 14, further comprising the mousepad according to any one of claims 1-13.
